(19) United States
(12) Patent Application Publication
(10) Pub. No.: US 2024/0301973 A1
(43) Pub. Date: Sep. 12, 2024

(54) Support System For Trapeze Arrangements

(71) Applicant: ERICO International Corporation, Solon, OH (US)

(72) Inventors: Steven McDaniel, Burton, OH (US); Jody Seubert, Appleton, WI (US); Eric J. Wilson, Solon, OH (US); Jeffrey A. Wilson, Cuyahoga Falls, OH (US); Raymond M. Olle, Valley View, OH (US)

(21) Appl. No.: 18/601,917

(22) Filed: Mar. 11, 2024

Related U.S. Application Data
(60) Provisional application No. 63/489,469, filed on Mar. 10, 2023.
(60) Provisional application No. 63/500,831, filed on May 8, 2023.

(51) Int. Cl. F16L 3/22; F16L 3/12

(52) U.S. Cl. CPC F16L 3/222; F16L 3/1222; F16L 3/1211

(57) ABSTRACT

A support system can include a first hanger body secured to a first hanger rod, a second hanger body secured to a second hanger rod, and a plurality of support bodies arranged between the first hanger body and the second hanger body. The support bodies may include conduit passages that receive corresponding lengths of conduit. A connector rod may extend through the first and second hanger bodies and the plurality of support bodies.

### CROSS-REFERENCE TO RELATED APPLICATIONS

This application claims priority to and incorporates by reference U.S. provisional patent application No. 63/489,469, filed Mar. 10, 2023, and U.S. provisional patent application No. 63/500,831, filed May 8, 2023.

### BACKGROUND

In many applications, it may be useful to suspend equipment such as conduit, pipe, and ducts from a ceiling or sidewall of a building. Suspending the equipment from the ceiling may help to create extra usable space in an interior of the building.

### SUMMARY

A modular prefabricated support system can include a first hanger body secured to a first hanger rod, a second hanger body secured to a second hanger rod, and a plurality of support bodies arranged between the first hanger body and the second hanger body. Each support body of the plurality of support bodies may include a conduit passage that receives a corresponding length of conduit, and a support passage that is transverse to the conduit passage. A connector rod may extend through the first and second hanger bodies and the plurality of support bodies. The connector rod may be supported by the first and second hanger rods via the first and second hanger bodies. The plurality of support bodies may be collectively supported by the connector rod to support the lengths of conduit.

A method of prefabricating a support system can include securing a first hanger body to a first hanger rod, and securing a second hanger body to a second hanger rod. The method may further include aligning a plurality of support bodies between the first and second hanger bodies. Each of the support bodies of the plurality of support bodies may include a conduit passage, and a support passage that may be transverse to the conduit passage. The method may additionally include inserting a connector rod through the plurality of support bodies and the first and second hanger bodies so that the connector rod is arranged to be supported by the first and second hanger rods via the first and second hanger bodies, and the plurality of support bodies are collectively supported by the connector rod. The method may also include inserting a corresponding length of conduit into the conduit passage of each support body of the plurality of support bodies. The method may further include securing the lengths of conduit within the conduit passages for transport collectively with the first and second hanger bodies and the first and second hanger rods.

A method of installing a conduit system can include securing a first hanger rod to a building structure, the first hanger rod being secured to a first hanger body. The method may also include securing a second hanger rod to the building structure, the second hanger rod being secured to a second hanger body. The first and second hanger rods may thereby support the first and second hanger bodies relative to the building structure. A connector rod may extend through the first and second hanger bodies, and through support passages of a plurality of support bodies arranged between the first hanger body and the second hanger body. The connector rod may be supported by the first and second hanger rods via the first and second hanger bodies. Additionally, the plurality of support bodies may be collectively supported by the connector rod to support lengths of conduit received transversely to the connector rod through conduit passages of the support bodies.

### BRIEF DESCRIPTION OF THE DRAWINGS

The accompanying drawings, which are incorporated in and form a part of this specification, illustrate configurations of the disclosed technology and, together with the description, serve to explain the principles of configurations of the invention:

FIG. 1 is an axonometric view of an example support system;

FIG. 2 is a front elevation view of the support system of FIG. 1;

FIG. 3 is an axonometric exploded view of the support system of FIG. 1;

FIG. 4 is an axonometric view of example support and spacer bodies of the support system of FIG. 1;

FIG. 5 is a front elevation view of an example coupler system for a support system;

FIG. 6 is an axonometric view of an example support body for a coupler system;

FIG. 7 is a front elevation view of an example coupler system for a support system, including the support body of FIG. 6;

FIG. 8 is an axonometric view of example support and spacer bodies for a support system;

FIG. 9 is a front elevation view of an example coupler system for a support system, including the support bodies of FIG. 8;

FIG. 10 is an axonometric view of an example support system;

FIG. 11 is an axonometric view of an example support system;

FIG. 12 is an axonometric view of an example support system;

FIG. 13 is an axonometric view of an example spacer body for a support system;

FIG. 14 is an axonometric view of an example coupler system for a support system, including the support bodies of FIG. 4, and with the coupler system in an installation orientation;

FIG. 15 is an axonometric view of an example hanger body of the coupler system of FIG. 14;

FIG. 16 is an axonometric view of the coupler system of FIG. 14 in a transport orientation;

FIGS. 17 and 18 are axonometric and exploded views of an example hanger assembly for a support system;

FIG. 19 is a cross-sectional view of the hanger assembly of FIGS. 17 and 18 in a transport orientation;

FIG. 20 is a cross-sectional view of the hanger assembly of FIGS. 17 and 18 in an installation orientation;

FIG. 21 is a partial schematic view of an example hanger assembly for a support system;

FIG. 22 is a partial schematic view of an example hanger assembly for a support system;

FIGS. 23 and 24 are axonometric views illustrating assembly of an example extended support system;

FIGS. 25-27 are axonometric views illustrating assembly of an example extended support system;

FIG. 28 is an axonometric view of an example extended support system mounted vertically;

FIG. 29 is an axonometric view of an example support system;

FIGS. 30 and 31 are axonometric views of example support bodies of the support system of FIG. 29;

FIG. 32 is an axonometric view of an example support system;

FIG. 33 is an axonometric view of an example support body of the support system of FIG. 32;

FIG. 34 is an axonometric view of the support body of FIG. 33 in a disassembled configuration;

FIG. 35 is an axonometric view of an example support system;

FIGS. 36 and 37 are axonometric views of an example support body of the support system of FIG. 35, from the rear and front respectively;

FIG. 38 is an axonometric view of an example coupler system for a support system;

FIG. 39A illustrates a rear elevation view of an example support body of the support system of FIG. 38;

FIG. 39B illustrates an axonometric view of the example support body of the support system of FIG. 38;

FIG. 40A illustrates a front elevation view elevation of the example support body of the support system of FIG. 38;

FIG. 40B illustrates an axonometric view elevation of the example support body of the support system of FIG. 38;

FIG. 40C illustrates a side elevation view elevation of the example support body of the support system of FIG. 38;

FIG. 41 illustrates an axonometric view of an example support body.

FIG. 42 is an axonometric view of an example coupler system for a support system;

FIGS. 43A and 43B illustrate left and right axonometric views of an example support body of the support system of FIG. 41.

FIG. 44 is an axonometric view of an example support system;

FIG. 45 is a front elevation view of the support system of FIG. 44;

FIG. 46 is an axonometric view of the support system of FIG. 44 in a transport configuration;

FIG. 47 is an axonometric exploded view of the support system of FIG. 44;

FIG. 48 is an axonometric view of an example support body of the support system of FIG. 44;

FIG. 49 is a front elevation view of the support body of FIG. 48;

FIG. 50 is a rear elevation view of the support body of FIG. 48;

FIG. 51 is cross-sectional view of the support body of FIG. 50, taken at LI-LI;

FIG. 52A is an axonometric view of an example hanger body of the support system of FIG. 44 in a first configuration;

FIG. 52B is an axonometric view of the example hanger body of the support system of FIG. 44 in a second configuration;

FIG. 53 is another axonometric view of the example hanger body of the support system of FIG. 44;

FIG. 54 is a front elevation view of an example coupler system for a support system;

FIG. 55 is a front elevation view of an example coupler system for a support system;

FIG. 56 is a front elevation view of an example coupler system for a support system;

FIG. 57A is a front elevation view of an example coupler system for a support system;

FIG. 57B is a bottom elevation view of the coupler system of FIG. 57A;

FIG. 58 is a front elevation view of an example coupler system for a support system;

FIG. 59 is a cross-sectional view of the coupler system of FIG. 58, taken at LIX-LIX;

FIG. 60A is a front elevation view of an example coupler system for a support system; and

FIG. 60B is a partially exploded front elevation view of an example coupler system for a support system.

### DETAILED DESCRIPTION

Before any configurations of the disclosed technology are explained in detail, it is to be understood that the disclosed technology is not limited in its application to the details of construction and the arrangement of components set forth in the following description or illustrated in the following drawings. The disclosed technology is capable of other configurations and of being practiced or of being carried out in various ways.

The following discussion is presented to enable a person skilled in the art to make and use configurations of the disclosed technology. Various modifications to the illustrated configurations will be readily apparent to those skilled in the art, and the generic principles herein can be applied to other configurations and applications without departing from configurations of the disclosed technology. Thus, configurations of the disclosed technology are not intended to be limited to configurations shown, but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of configurations of the disclosed technology. Skilled artisans will recognize the examples provided herein have many useful alternatives and fall within the scope of configurations of the disclosed technology.

As noted above, in some contexts, it may be useful to suspend equipment (e.g., conduit, pipe, and ducts) above the ground in buildings. Multiple lengths of such equipment are often run side by side and hung from a ceiling or other overhead support structure. Conventional configurations of such support systems require the conduit to be suspended using horizonal support struts that are threadedly connected to a ceiling, via a hanger bar. In particular, standardized strut is typically used, including a straight horizontal bar with an internal track for receiving one or more clamps or other components. However, this approach requires an installer to manually set the spacing between each clamp on the strut, as well as being subject to limitations in adaptability inherent to the uniform strut profile. Thus, for example, attempting to coordinate two or more lengths of conduit across multiple support struts is a challenging and time-consuming process that may involve laborious adjustment.

In order to save time for on-site installation, sections of such side-by-side conduit are often prefabricated at one location and then shipped to a construction site to be quickly installed in completed subassemblies. For such prefabrication applications, it may be practical to pre-space both the axial and lateral positions of the individual lengths of conduit so that each section will correctly connect with each other during the install of the support system. For similar reasons as discussed above, conventional support systems may not provide an efficient approach for ensuring correct spacing of conduit clamps during prefabrication. This can lead to misaligned conduit, and labor-intensive readjustment during prefabrication or installation.

Further, conventional prefabricated conduit-strut support systems may not provide an efficient transportation configuration. For example, with conventional strut arrangements as discussed above, vertical hanger bars connected to the strut remain in an upright position during transportation. This can significantly reduce the amount of usable space within a transport vehicle and the ease of transport for support systems in general.

Configurations of the present disclosed technology may address these and other issues, including reducing the installation time for equipment support systems (e.g., to support conduit, pipe, and ducts). For example, through the use of individual support bodies, connected via a connector rod, some configurations can reduce the need for the manual realignment of one or more clamps along a length of strut during installation. Using individual support bodies may also reduce the burden on prefabricators in determining the location of each clamp during prefabrication and aligning each of the clamps accordingly.

In some configurations, a plurality of individual support bodies, each including a conduit passage, can define a predetermined spacing between the conduit passage and an edge of the support body. When the support bodies are installed together, this may eliminate the need for prefabricators to attempt to correctly manually space conduit clamps along an assembly.

In some configurations, a plurality of individual support bodies may each be connected to a respective length of conduit, and further connected to one another via a connector rod. Thus, some examples can provide a modular support system that can be easily replicated by simply connecting the same individual support bodies in the same pattern, or easily adapted to different arrangements by swapping in different support bodies.

In some examples, an assembly of support bodies may be suspended using rotatable assemblies. For example, hanger bodies secured to a connector rod can be rotatable relative to corresponding support bodies (e.g., rotatable about the connector rod), so that the hanger bodies can rotate corresponding hanger rods between an installation orientation and a transport orientation. The hanger rods can thus be selectively positioned at different angular orientations (i.e., with a corresponding angular offset between the hanger rods) with the transport orientation in particular reducing the amount of space taken up by each support system during transportation. For example, hanger rods may extend substantially perpendicularly to supported conduit in the installation orientation (e.g., substantially vertically), and may extend substantially parallel with supported conduit in the transport orientation (e.g., substantially horizontally).

In some configurations, a support system can include a plurality of support bodies secured in series along a connector rod. One or more hanger rods can be connected to the connector rod by one or more corresponding hanger bodies (e.g., at opposing axial ends of the connector rod or array of support bodies), to suspend the support bodies via the connector rod. In particular, the connector rod may extend through the support bodies to couple the one or more support bodies to the support system. The support bodies may include one or more conduit passages that are configured to receive a length of conduit, or other similarly elongate equipment (e.g., tubing, piping, or ducts).

In some configurations, the support system includes a plurality of sizes of support bodies. For example, some support bodies can include conduit passages of various sizes, including as can allow a support system (or body) to receive more than one size of conduit or tubing (or other equipment). In some configurations, support bodies can be configured to receive more than one conduit (or other equipment). In some configurations, support bodies can be configured as spacer bodies and may not necessarily directly support conduit or other equipment.

In some configurations, support bodies or hanger bodies can be configured to interlock for improved spacing and stability. For example, some support bodies may include a protrusion and an opening that are arranged and sized so that the protrusion can engage an opening of an adjacent support body (and vice versa). In some examples, such an arrangement can help to secure a hanger body in particular at either of an installation orientation or a transport orientation.

Generally, support bodies according to this disclosure can be manufactured in a variety of ways, including as further detailed below. For example, in various implementations, support bodies can be solid-body bodies formed by extrusion or casting, integrally cast plate structures, or integrally stamped plate structures, or can be additively manufactured—in each case with various complexities of shape (e.g., as further detailed below).

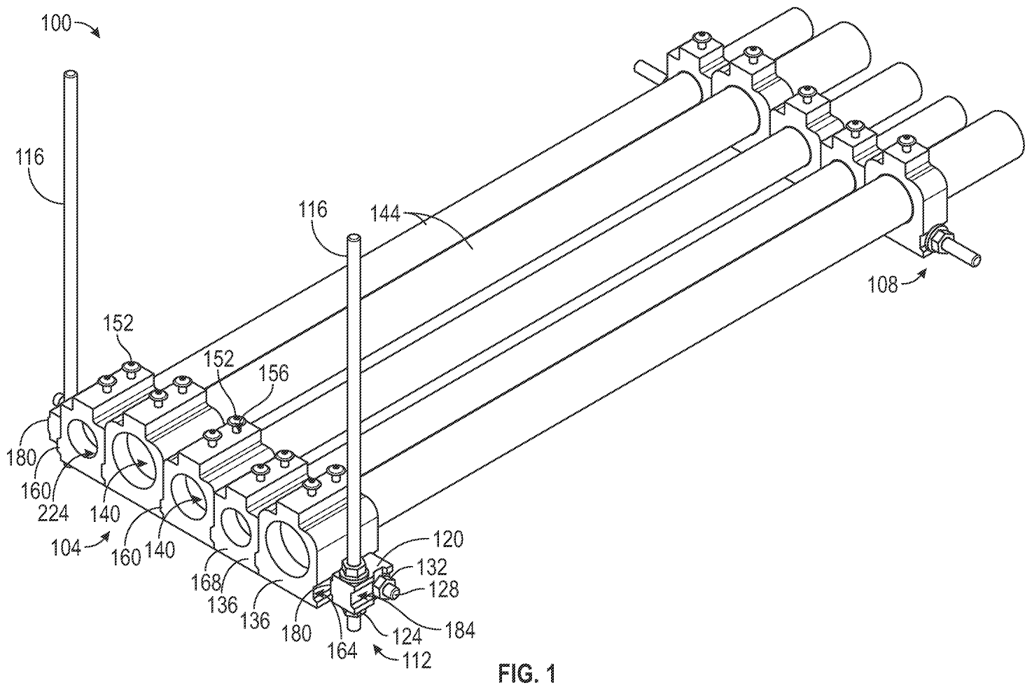

As one example, FIG. 1 illustrates a modular support system 100 for supporting equipment, as can be installed to hang from walls, ceilings, support beams, etc., on the exterior or interior of a building. In the example shown, the support system 100 includes a coupler system 104 and a spacer system 108. The coupler system 104 and the spacer system 108 may be substantially similar, therefore any description of the coupler system 104 may generally apply to the spacer system 108, and vice versa. However, some differences can be provided, including as detailed below. In some installations, the support system 100 may be fully functional without the coupler system 104 or without the spacer system 108 (e.g., with the coupler system 104 used independently from the spacer system 108, or vice versa). Further more than one of the support systems 100 may be joined together to accommodate longer or heaver equipment (i.e., tubing, piping, conduit, and ducts), or otherwise provide an extended-length support system for particular installations.

The coupler system 104 may include a hanger assembly 112. The hanger assembly 112 may include one or more hanger rods 116, one or more hanger bodies 120, one or more hanger rod fasteners 124, one or more connector rods 128, and one or more connector rod fasteners 132. The hanger assembly 112 may be configured to support a plurality of support bodies 136. In particular, the system 104 as shown in FIG. 1 and detailed below includes a single connector rod 128, two hanger bodies 120, and two hanger rods 116 that cooperatively support conduit (etc.), although other configurations are possible.

In the example depicted in FIG. 1, the hanger rods 116 extend upward from the hanger assemblies 112, and are coupled to the hanger bodies 120 via the hanger rod fasteners 124 (e.g., nuts, as shown, to engage threaded ends of the rods 116). The connector rod 128 extends between hanger bodies 120, and is secured to the hanger bodies 120 via the connector rod fasteners 132 (e.g., nuts, as shown, to engage threaded ends of the rod 128). The hanger rods 116 may be coupled to the hanger rod fasteners 124 via threading (as shown), or with various other couplings (e.g., press fit connections, C- or E-clips, or rivets, etc.). Similarly, the connector rods 128 may be coupled to the connector rod fasteners 132 with a threaded connection, or with another coupling.

In another configuration the hanger rods 116 or the connector rods 128 may be coupled directly to the hanger bodies 120 via threading, or other known methods of coupling. Coupling the hanger rods 116 or the connector rods 128 directly to the hanger body 120 may reduce number of components needed to build the hanger assembly 112. However, as further discussed below, the hanger bodies 120 can in some cases be configured to rotate relative to a connector rod (or other components) to provide improved configurations for transport and installation.

Generally, the support bodies 136 can be configured to support conduit or equipment relative to the corresponding hanger rod 116. For example, as shown in FIG. 1, the support bodies 136 may include one or more conduit passages 140 configured to receive one or more lengths of conduit 144. As shown in FIG. 1, each of the passages 140 can be round and can be arranged to accommodate multiple sections of conduit in parallel. However, other configurations are possible.

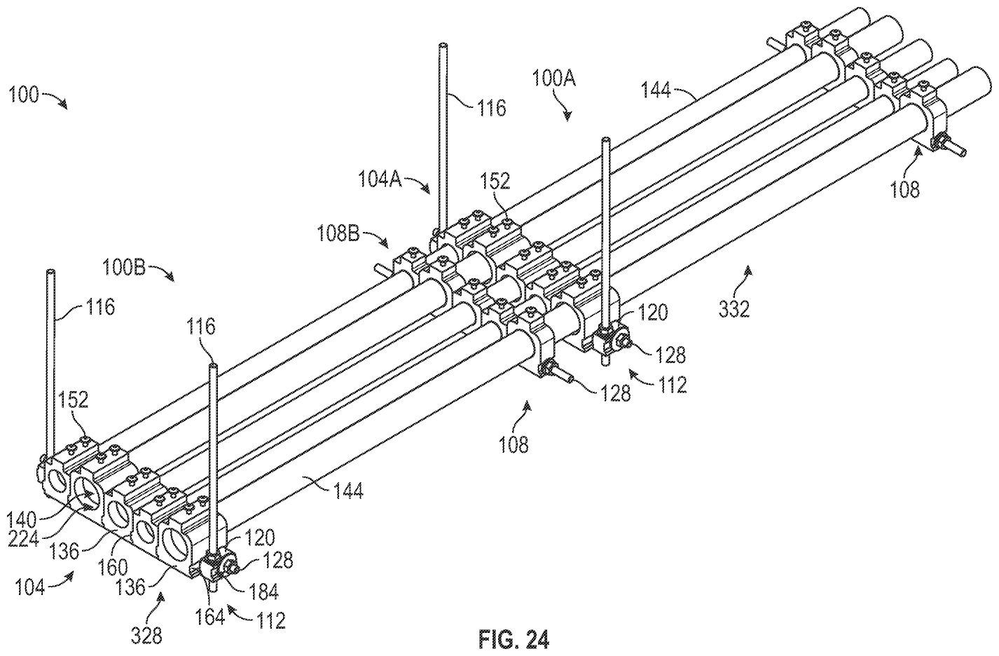

The one or more conduit passages 140 may be substantially parallel to the one or more lengths of conduit 144. The one or more conduit passages 140 may be transverse (e.g., substantially perpendicular) to one or more support passages 148 for the connector rod 128. The lengths of conduit 144 may run substantially parallel to one another through the one or more conduit passages 140. Further, as also discussed below, (see e.g., FIG. 24) the conduit passages 140 can in some cases receive opposing ends of separate lengths of conduit 144 to couple the lengths together at the passages 140.

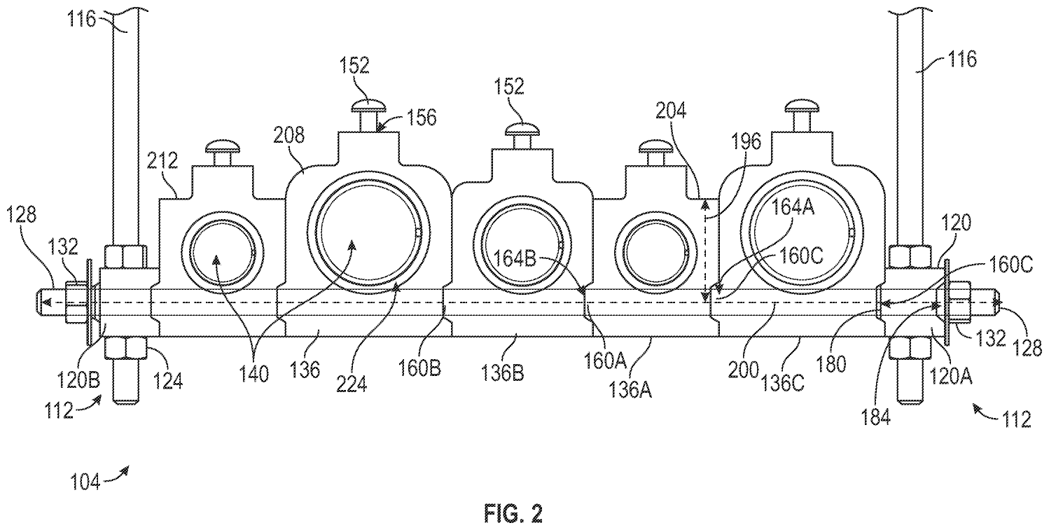

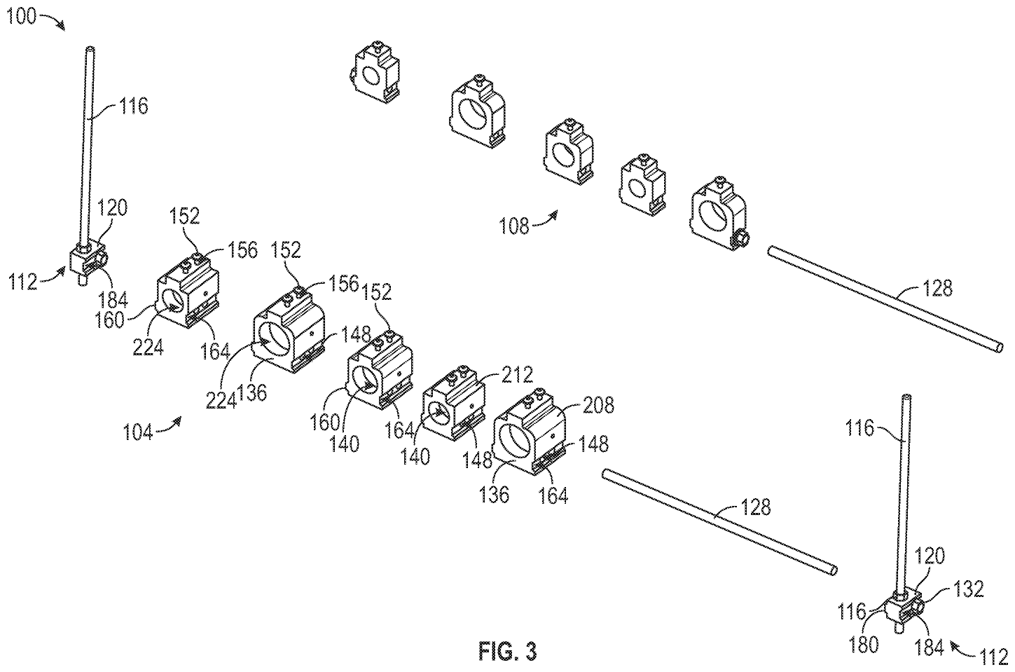

As also noted above, the support bodies 136 may further include the support passages 148 (see, e.g., FIGS. 2 and 3), which can be configured to receive the corresponding connector rod(s) 128. As shown in FIG. 1, two of the support passages 148 can be included in some of the support bodies 136, with circular profiles in particular. Such an arrangement can allow easy and adaptable installation of one or more connector rods through an array of the support bodies 136. However, other configurations are possible.

In the example depicted in FIG. 1, the support bodies 136 are disposed between the hanger bodies 120 (e.g., a first and second hanger body 120A, 120B), which are arranged at opposing axial ends of the connector rod 128. The connector rod 128 extends through the support passage 148 of each support body 136 (see FIGS. 2 and 3) to provide a common support to suspend the support bodies 136 from an overhead structure, along with the received lengths of conduit 144. Though the illustration of FIG. 1 depicts five support bodies 136 supporting five lengths of conduit 144, the lateral extension of the connector rod 128 may be varied, or the assembly overall otherwise changed, to allow for different numbers of the support bodies 136 to be supported by the hanger assembly 112. As will be described further below, the support bodies 136 of the support system 100 may be substantially identical, or may vary in size, shape, and purpose. In some examples, the hanger bodies 120 may also be substantially identical, or may vary in size, shape, and purpose.

The support bodies 136 may include one or more conduit fasteners 152 (e.g., set screws, rivets, bolts, clips, or other known fasteners) which may further secure the lengths of conduit 144 within each conduit passage 140. The one or more conduit fasteners 152 may be screwed through one or more threaded holes 156 disposed in the support body 136. In some examples, as further discussed below, multiple fasteners can be provided to secure multiple conduit sections to the same support body and thereby join different conduit sections in axial alignment at a common support body. In other configurations, the conduit passage 140 may not include the one or more conduit fasteners 152 or the corresponding holes 156 (e.g., with other arrangements provided to secure conduit.

In some examples, support bodies can include features to help align adjacent support bodies relative to each other as well as improve the overall loading of a support system. For example, as shown in FIGS. 1 through 3, the support bodies 136 may also include one or more support body protrusions 160 and one or more support body openings 164. In general, a support body protrusion of a first support body may be arranged to engage a support body opening of an adjacent one of the support bodies 136 (or other component) and the support body opening of the first body may be similarly arranged to engage a support body protrusion of an adjacent support body (on an opposing side of the first body).

For example, as shown in FIG. 2 in particular, the protrusions 160 of one of the support bodies 136 can be received into the opening 164 of an adjacent one of the support bodies 136 along the length of the connector rod 128. Specifically, FIG. 2 illustrates at least a first, second, and third support bodies 136A, 136B, 136C each including a respective first, second, and third protrusion 160A, 160B, 160C and a respective first, second, and third support body opening 164A, 164B, 164C. The first, second, and third support bodies 136A, 136B, 136C may be disposed in a row, such that the second and third support bodies 136B, 136C are each disposed adjacent the first support body 136A. The second and third support bodies 136B, 136C may further be disposed on axially opposite sides of the first support body 136A along the connector rod 128. In the illustrated configuration, the first protrusion 160A of the first support body 136A may engage the second opening 164B of the second support body 136B. Furthermore, the third protrusion 160C of the third support body 136C may engage the first opening 164A of the first support body 136A. Among other benefits, this engagement may help to secure the array of support bodies 136A, 136B, 136C (including any number of support bodies 136), in general, against relative rotation.

Generally, it may be important to ensure that a support system 100 is able to withstand the shear loading and the moment loading associated with the weight supported by the coupler system. In some examples, the size and orientation of particular features of a support body can be designed to increase the resistance of a support system to such loading. For example, as shown in FIG. 2, alignment (or other) features of the coupler system 104 may also employ friction and complementary features to transfer shear between the adjacent support bodies 136 and help withstand moment loading.

In particular, the support body protrusions 160 and the support body openings 164 may be generally complementary features, so that a shape of the support body protrusions 160 may fit snugly within a shape of the support body openings 164. Such a complementary configuration and engagement of the support bodies protrusions 160 and the support body openings 164 may assist in the strength of the coupler system 104. For example, the close engagement of the support body protrusions 160 with the support body openings 164 as shown in FIG. 2 can help to distribute the shear loading across the entire coupler system 104 (and reduce shear loading on the connector rod 128 in particular), thereby potentially increasing the amount of load that the coupler system 104 can support. In some examples, the support body protrusions 160 and the support body openings 164 may be aligned along the connector rod 128 when assembled in the support system 100. More specifically, the connector rod 128, and therefore the connector passage 148 may extend through the support body protrusions 160 and the support body openings 164. Although trapezoidal profiles are shown, a support body protrusion or opening may be another shape in other examples (i.e., rectangular, semi-circular, triangular, etc.). Further, similar arrangements can also be provided on a spacer system (e.g., the spacer system 108 as shown in FIGS. 1 and 3).

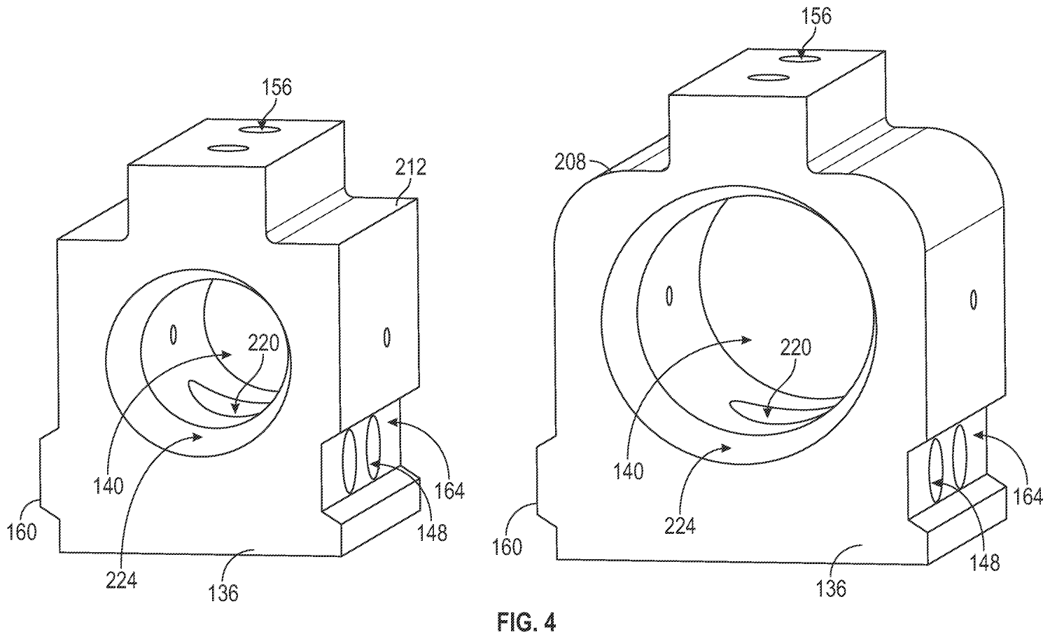

As illustrated in FIGS. 3 and 4, the support body opening 164 may extend only partially through the support body 136 in a direction parallel to the connector rod 128. For example, the support body opening 164 may include a relatively shallow recess (as shown). However, as will be described further below, an opening may instead be a through-hole extending through at least a sidewall of the support body.

In some cases, hanger (or other) bodies can include similar arrangements of protrusions and openings. For example, as depicted in FIG. 2, the hanger bodies 120 may include a hanger body protrusion 180 and a hanger body opening 184. A shape of the hanger body protrusion 180 may be complementary to at least part of the shape of the support body opening 164. Similarly, a shape of the hanger body opening 184 may be complementary to at least part of the shape of the support body protrusion 160. The hanger body protrusion 180 and the hanger body opening 164 may thus also assist in the distribution of shear within the coupler system 104, similar to the support body protrusions 160 and the support body openings 164 as discussed above. Specifically, the first hanger body 116A may include a first hanger body protrusion 180A, configured to engage a fourth support body opening 164D of a fourth support body 136D disposed adjacent a first end of the coupler system 104. Additionally, the second hanger body 116B may include a second hanger body opening 184B, configured to engage a fifth support body protrusion 160E of a fifth support body 136E disposed adjacent a second end of the coupler system 104, axially opposite the first end along the connector rod 128.

In some examples, similar to the support body protrusions 160 and openings 164, the hanger body protrusion 180 and the hanger body opening 184 may be aligned with the connector rod 128 when assembled in the support system 100. Similarly, although trapezoidal profiles are shown, the hanger body protrusion 180 may be another shape in other examples (i.e., rectangular, semi-circular, triangular, etc.).

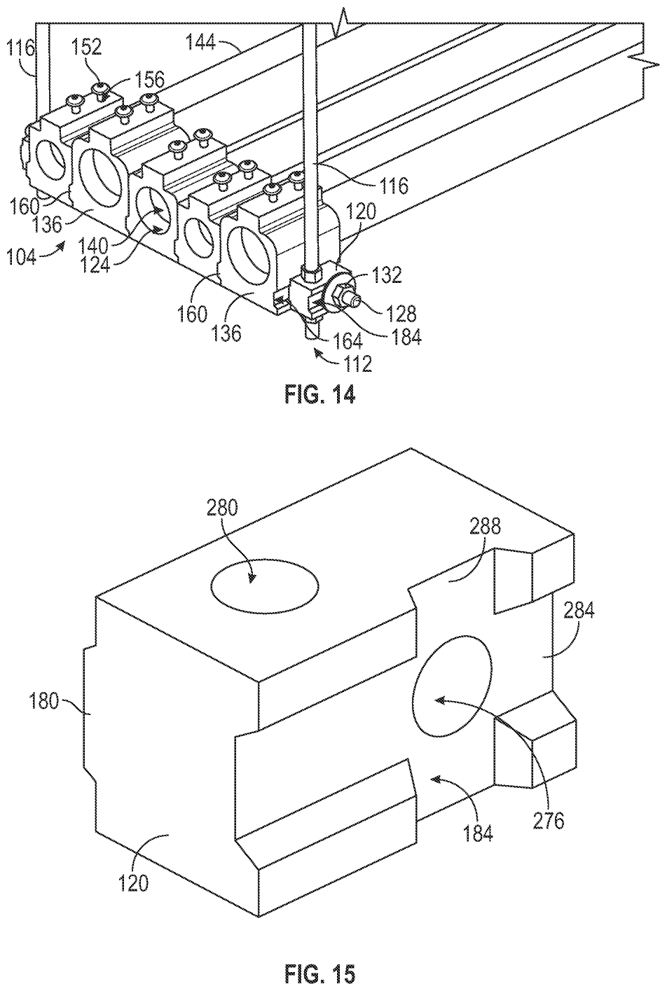

As illustrated in FIGS. 14 and 15, the hanger body opening 184 may extend only partially through the hanger body 120 in a direction parallel to the connector rod 128. For example, the hanger body opening 184 may include a relatively shallow recess (as shown). However, as will be described further below, a hanger body opening may instead be a through-hole extending through at least a sidewall of a hanger body.

As suggested earlier, the shear loading and moment loading may also be beneficially distributed by increasing the friction between the support bodies 136. It is contemplated that the friction between support bodies 136 may be increased by increasing the force pushing the bodies against one another. One such method of increasing the force holding the support bodies 136 together may include increasing a tension on the connector rod 128. The tension on the connector rod 128 may be increased by tightening the one or more of the connector rod fasteners 132. Increasing the tension in the connector rod 128 may compress the support bodies 136 further together, increasing a normal force between the support body 136, therefore increasing the friction between the support bodies 136.

Continuing with respect to loading features, the magnitude of the moment that can be withstood by the coupler system 104 (or a support system in general) may be dependent on the strength of the connector rod 128 as well as on a vertical distance 196 between a centerline 200 of the connector rod 128 and a top contact region 204 between adjacent support bodies 136. Therefore, the magnitude of the moment that can be withstood may be increased by increasing the diameter of the connector rod 128, increasing the number of connector rods 128, or selecting suitably strong material for the connector rod 128. In some cases, the magnitude of the moment that can be withstood may also be increased by increasing the vertical distance 196 between the centerline 200 of the connector rod 128 and the top contact region 204 between adjacent support bodies 136. In particular, the vertical distance 196 may thus be determined by the size of the support bodies 136 and the manner in which adjacent bodies engage each other. Accordingly, the support bodies 136 that exhibit larger inter-body contact heights relative to a connector rod may be capable of supporting wider or heavier equipment arrays. Correspondingly, the bodies 136 can be designed to provide relatively large distances 196 in some cases, including as further discussed below.

In particular, FIG. 2 depicts multiple sizes of support bodies 136 suspended in the same coupler system 104. The depicted support bodies 136 can include either a filleted top contact region 208 or a cornered top contact region 212. The presence of the cornered top contact region 212 may effectively increase the vertical distance 196 of the support body 136, as compared to an otherwise similar support body with a filleted top contact region. Further, as generally noted above, increasing the vertical distance 196 may increase the number of support bodies 136 that the coupler system 104 may support. Correspondingly, use of cornered rather than filleted top contact regions for support bodies 136—particularly for smaller sizes of the support bodies 136—can increase the rated capacity of a particular support assembly. Although FIG. 2 depicts the cornered top contact regions 212 only on relatively smaller support bodies 136, the same principle can be used to increase the vertical distance 196 for any size of the support bodies 136.

In some examples, a support body can include a viewing aperture. For example, as shown in FIG. 4, various configurations of the support bodies 136 may include a viewing aperture 220 in the bottom of the support body 136. The viewing aperture may be used, for example, to verify that a relevant length of conduit 144 is properly seated within the conduit passage 140. FIG. 4 further depicts that the conduit passage 140 may include a funneled (or otherwise tapered) opening 224. The funneled opening 224 may assist with alignment for insertion of a length of conduit into the conduit passage 140.

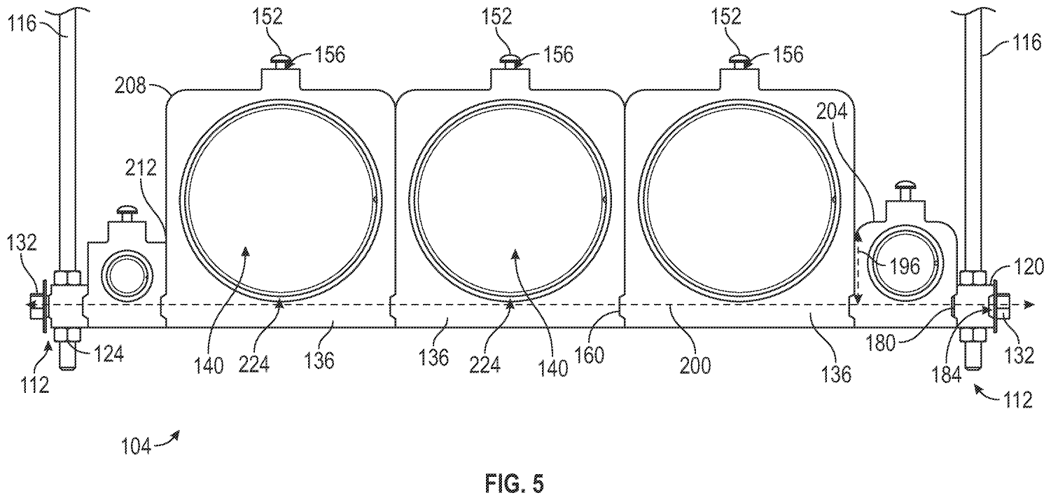

In different examples, as generally noted above, different sizes of support bodies can be used. For example, FIG. 5 depicts the coupler system 104 including multiple larger support bodies 136 situated toward the middle of the length of the connector rod 128, and multiple smaller support bodies 136 situated toward opposing axial ends of connector rod 128. Of note, the magnitude of the moment may be greater toward a middle of a length of the connector rod 128. To better support a support system at areas of greater moment on the connector rod 128, it may therefore be beneficial to place the larger support bodies 136 towards the middle of the connector rod 128, to increase the vertical distance 196 of the support bodies 136 at corresponding locations. However, some configurations of the coupler system 104 may not include the larger support bodies 136 towards (or only towards) the middle of the connector rod 128.

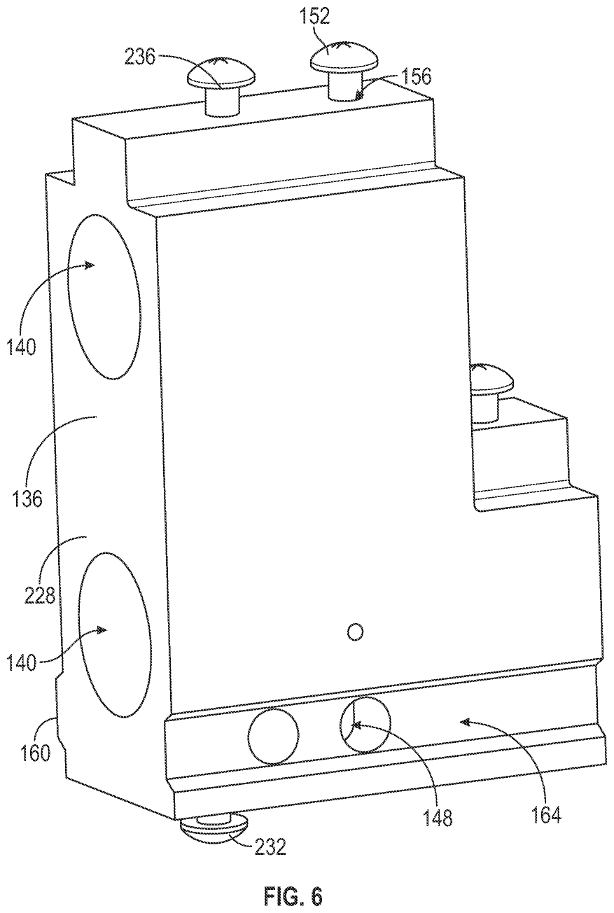

In some examples, as also generally noted above, multiple lengths of conduit can be received in a single support body. For example, FIG. 6 depicts a double support body 228 as another example configuration of the support body 136, with multiple conduit passages 140. The multiple conduit passages 140 of the double support body 228 may be configured to receive multiple lengths of conduit 144. Correspondingly, some support bodies can include fasteners aligned to secure each of multiple received conduit. For example, the depicted support body 228 includes a first set of conduit fasteners 232 and a second set of conduit fasteners 236. The first set of conduit fasteners 232 may be configured to fasten a first length of conduit within a first of the conduit passages and the second set of conduit fasteners 236 may be configured to fasten a second length of conduit within a second of the conduit passages. Thus, for example, the second set of conduit fasteners 236 may be radially or axially offset from the first set along a radial or axial direction of the conduit (not shown) so as to be extendable into the lower passage 140 without interference with the upper passage 140. In other example, however, other configurations are possible, including those with different numbers or other arrangements of conduit passages or corresponding fasteners.

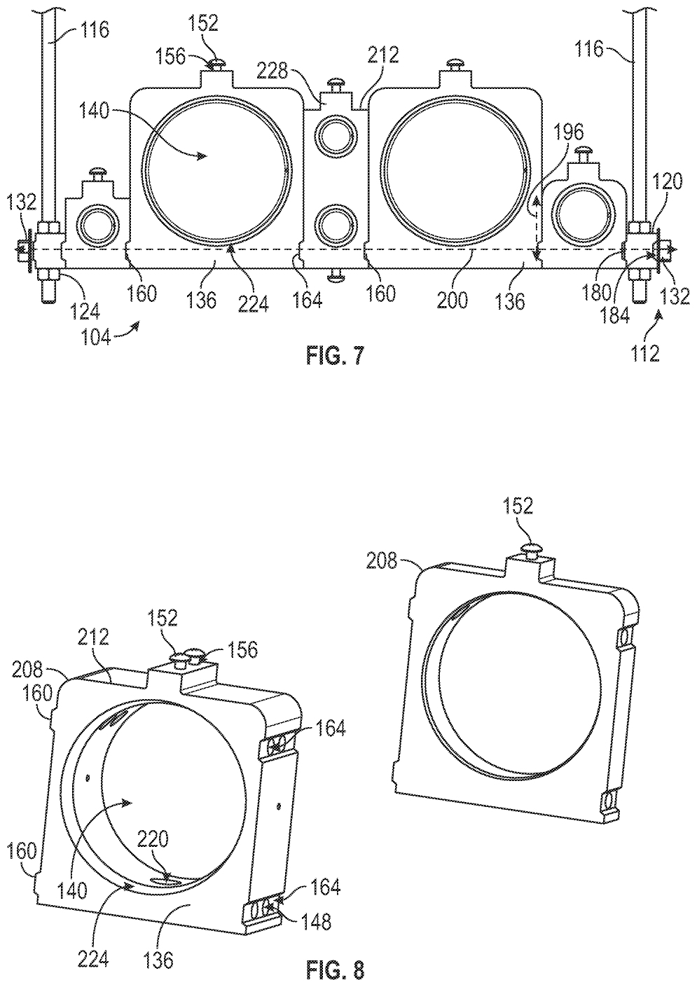

FIG. 7 depicts another configuration of the coupler system 104, including multiple large support bodies 136 situated towards the middle of the length of the connector rod 128, and multiple small support bodies 136 situated outside of the larger support bodies 136 (i.e., in a lateral direction for the bodies 136, corresponding to an axial direction of the connector rod 128). As described above, increasing vertical distance 196, may allow the coupler system 104 to support more support bodies 136 and therefore more lengths of conduit (or other equipment). Thus, for example, the double support body 228 of FIG. 6 may be placed between the larger support bodies 136 to increase the corresponding vertical distance 196. The support body 228 also thus saves space by allowing installers to vertically stack multiple lengths of conduit (not shown in FIG. 7). In this regard, the use of a multi-conduit support body (e.g., the support body 228) may provide further advantages over the use of conventional system. For example, conduit installed on strut with conventional clamps may be difficult to stack, potentially requiring the installer to use longer pieces of strut to accommodate more lengths of conduit 144.

In some examples, a particular side of a support bodies can include multiple features to engage an adjacent support body. For example, FIG. 8 depicts support bodies 136 that include multiple support body protrusions 160 and multiple support body openings 164 (e.g., two of each, as shown). As described above, the body protrusions 160 may be arranged to engage the body openings 164 of an adjacent support body 136 and the support body openings 164 may be arranged to engage the support body protrusions 160 of an adjacent support body 168 on an opposing side. As also discussed above, this may help to secure adjacent support bodies 136 against relative rotation.

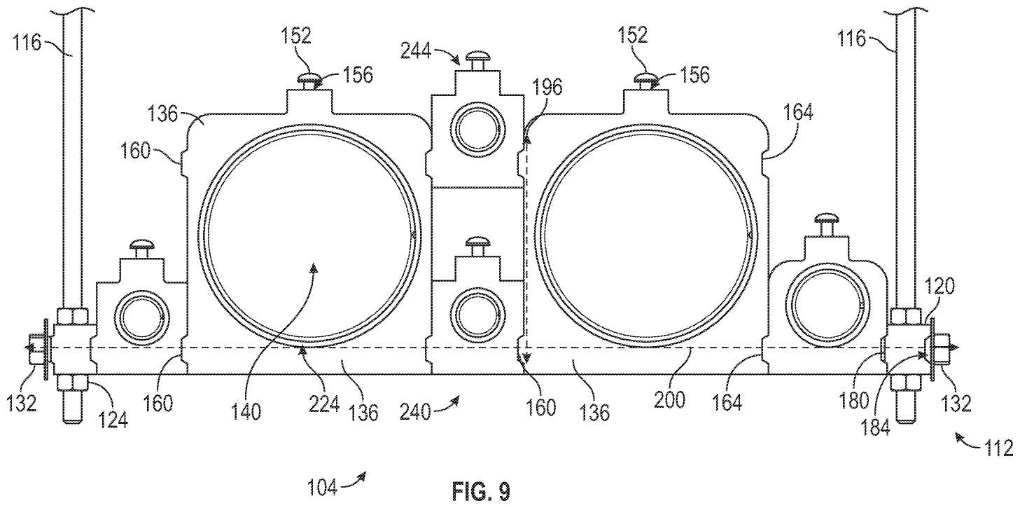

FIG. 9 depicts the multiple support body protrusions 160 and the multiple support body openings 164 of FIG. 8 engaged with adjacent support body protrusions and support body openings. Including extra of the support body protrusions 160 and support body opening 164 may further aid in the transfer of shear loading across the entire coupler system 104, potentially further increasing the amount of load that the coupler system 104 can support.

In some examples, support bodies 136 that include multiple support body protrusions 160 and multiple support body openings 164 may be capable of engaging of multiple adjacent support bodies 136 (e.g., that include a comparatively fewer number of the support body protrusions 160 and the support body openings 164). As illustrated in FIG. 9, for example, two support bodies 136 as configured in FIG. 8 can engage two smaller support bodies 136 that include one respective support body protrusion and one respective support body opening 164. For example, as shown, a first of the smaller support bodies 136 can be secured in an upper position 244 and a second of the smaller support bodies 136 can be secured in a lower position 240 (e.g., spaced apart from the upper position 244). Stacking the two smaller support bodies 136, as shown in FIG. 9, between two larger support bodies 136, again may increase the vertical distance 196, which may allow the coupler system 104 to withstand a larger moment, and accommodate more lengths of conduit 144. Thus, the arrangement in FIG. 9 can in some cases provide a more adaptable alternative to the integral stacked configuration provide by the support body 228 illustrated in FIGS. 6 and 7.

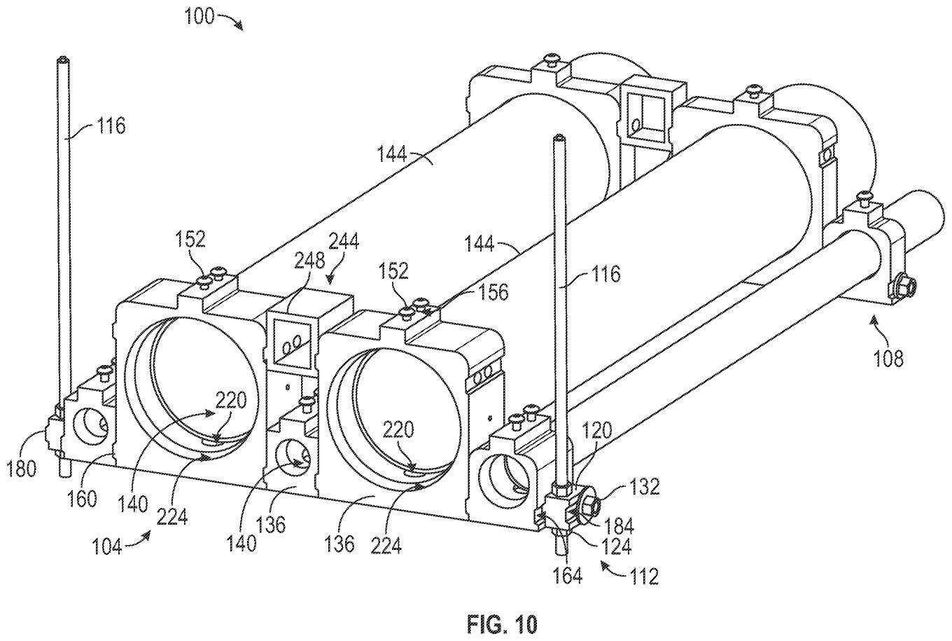

In some examples, a body not specifically configured to support conduit or other equipment can be used otherwise similarly to the various support bodies discussed herein, to provide improved structural characteristics to a support system. For example, FIG. 10 depicts a blank body 248 that may be used to occupy space and provide structural stability, but may not necessarily receive a length of conduit. The blank body 248 of FIG. 10 is situated in the upper position 244 as also discussed above with respect to FIG. 9, although other configurations are possible. Stacking the smaller support body 136 in the first position 240 and the blank body 248 in the second position 244, between the two larger support bodies 136, may again increase the vertical distance 196, despite the relatively small size of the middle support body 136 (in the example shown), which may allow the coupler system 104 to withstand a larger moment so that the coupler system 104 can accommodate more lengths of conduit 144.

FIG. 11 depicts another configuration with the blank body 248. In some situations, one or more of the lengths of conduit 144 may be diverted during the middle of a run, leaving an empty space 252 between the lengths of conduit 144 supported by the support system 100 (e.g., that extend substantially in parallel). In order to fill the empty space 252 at the coupler system 104 (or otherwise) and maintain a width and spacing of the coupler system 104 relative to the supported conduit 144, the blank body 248 (or another configuration of the support body 136) may be used.

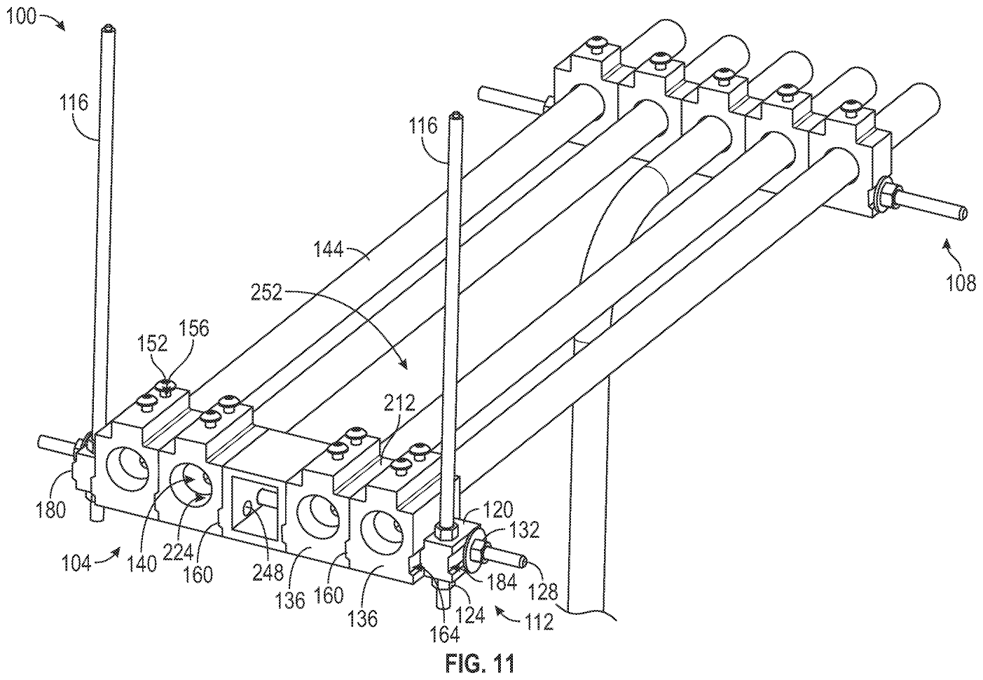

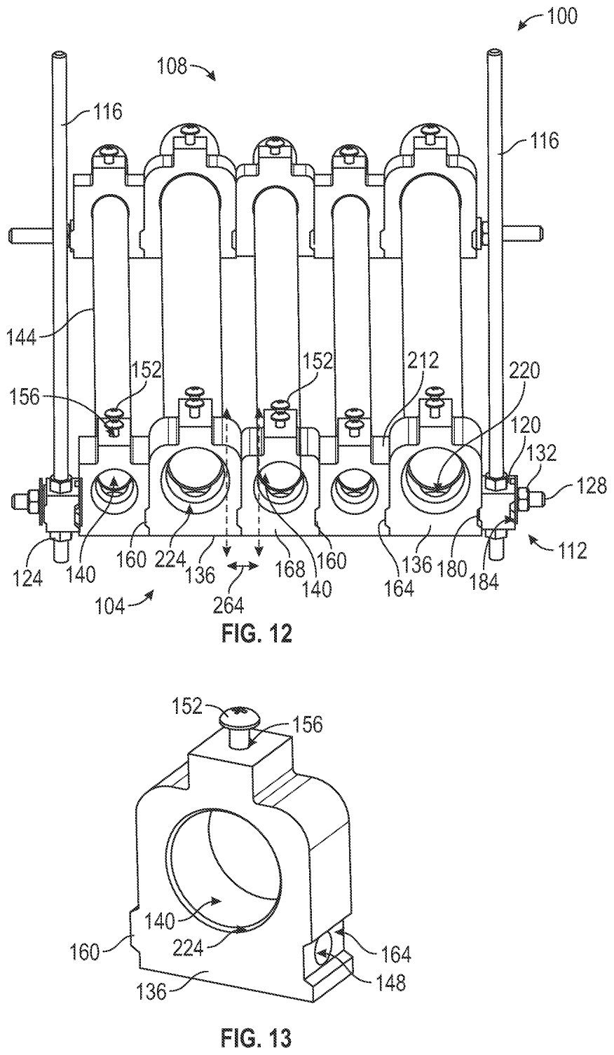

In prefabrication and other operations, it may be important to correctly space the individual lengths of conduit 144 along a connector rod so that each section of conduit will be appropriately aligned with the next (e.g., to fit into a coupler with the next section). As another potential benefit of the disclosed support systems, the support bodies 136 can be installed to automatically set a desired spacing between the lengths of conduit 144. Such automatic spacing can make both prefabrication assembly and on-site installation faster and easier, as the conduit from different sections may be reliably configured in appropriate alignment. For example, as shown in FIG. 12 in particular, a desired spacing may be built into a set of the support bodies 136 that can provide a corresponding spacing between adjacent sections of the conduit 144 regardless of the diameter of the length of conduit 144 that any one of the support bodies 136 is configured to support. In some cases, consistent spacing between the lengths of conduit 144 may thus be automatically maintained, with each set (or at least multiple sets) of adjacent lengths of conduit 144 being separated transversely by a common distance 264. Similar spacing can then be provided at other parts of the support system 100 (e.g., other spacer or coupler assemblies) or in other related support systems for easy alignment of multiple sections of conduit. Although a side-to-side spacing of conduit is shown, some support systems can be configured to similarly provide consistent center-to-center spacing, even for different sizes of conduit.

As also noted above, support systems can variously include coupler systems with support bodies that receive separate lengths of conduit in opposing axial directions to couple the conduit together at the support body. Some support systems can also (or alternatively) include spacer systems with support bodies that are configured as spacer bodies to support and maintain spacing for conduit without joining axially aligned lengths of the conduit together (at the spacer bodies). For example, as generally shown in FIGS. 1 and 10-12, a spacer body can be configured to receive a single length of conduit (or multiple conduits) fully there-through, rather than receive pairs of axially aligned conduit from opposing axial directions. Similar to the coupler system 104, the spacer system 108 may be secured together by a connector rod extending 128 through a support passage of each spacer block.

In particular, FIG. 13 depicts an example of the support body 136 configured as a spacer body of the spacer system 108 of FIG. 1. Similar to the support body 136 from the coupler system 104, the support body 136 from the spacer system 108 may include one or more of the conduit fasteners 152, one or more of the threaded holes 156, one or more of the conduit passages 140 (e.g., with the funneled openings 224), one or more of the support passages 148, one or more of the support body protrusions 160, and one or more of the support body openings 164. Correspondingly, spacer bodies can generally be formed and installed similarly to the support bodies 136 discussed above (and below), to provide similar benefits for strength and adaptability of support systems. Further, predetermined spacing between conduit for spacer systems can in some cases correspond to predetermined spacing for associated coupler systems, such that the coupler and spacer systems can be easily used together (or separately) to support conduit with appropriate spacing over an extended length. Correspondingly, in some cases, the support bodies 136 of the spacer system 108 may be generally configured and used similarly to the support bodies of coupler system 104 (although not necessarily to specifically couple axially aligned conduit together at the relevant spacer body).

In some examples, as generally discussed above, a support system can be configured to be adjustable between a transport orientation and an installation orientation. In this regard, for example, FIG. 14 illustrates the hanger assembly 112 in an installation orientation. In particular, the hanger rods 116 are oriented substantially perpendicular to the lengths of conduit in the illustrated installation orientation, although other configurations are possible.

In some examples, a hanger body can include features that can assist in selectively securing a support system in a particular orientation (e.g., a transport or installation orientation). For example, as shown in FIG. 15 and as noted above, the hanger body 120 may include the hanger body protrusions 180 and the hanger body openings 184. The hanger body 120 may further include a connector rod through-hole 276 and a hanger rod through-hole 280, extending transversely (e.g., substantially perpendicularly) to each other to receive the connector rod 128 and the hanger rod 116, respectively, as generally discussed above. Further, the hanger body opening 184 of the example hanger body 120 includes a first opening portion 284 and a second opening portion 288 which extends transverse to and intersects the first opening portion 284 (e.g., to form an opening cross profile, as shown). Further, the connector rod through-hole 276 is aligned at the intersection of the first opening portion 284 and the second opening portion 288. Similar to the support body opening 164, the first opening portion 284 and the second opening portion 288 may extend only partially through the hanger body 120 in a direction parallel to the connector rod 128. For example, the first and second opening portions 284, 288 may include relatively shallow recesses (as shown).

Thus, for example, the first opening portion 284 may be configured to engage with the support body protrusion 160 while the hanger assembly 112 is in the installation orientation as shown in FIG. 14. In particular, with appropriate tightening of relevant fasteners on the connector rod 128 (or an otherwise secured connection), the hanger body openings 184 and the hanger body protrusions 180 may cooperatively provide detents to prevent rotation of the hanger assembly 112 (and the rod 116 in particular).

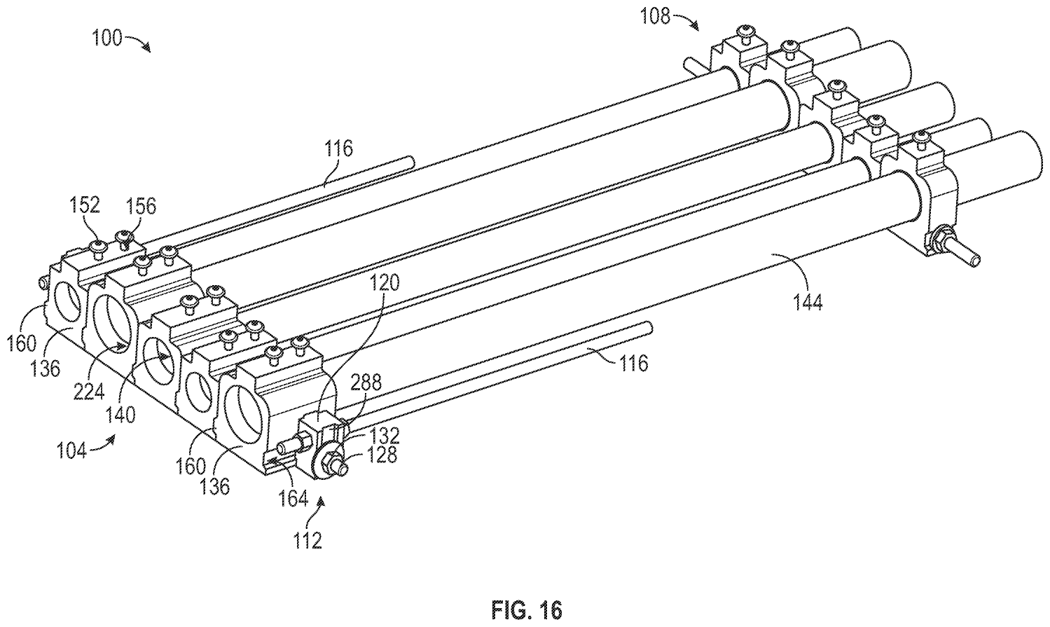

Further, the hanger assembly 112 can then be rotated relative to the support bodies 136 (e.g., with or about the connector rod 128), to rotate the hanger body 120 around the connector rod 128 and thus orient the hanger rods 116 in the transport orientation, as depicted in FIG. 16. In the transport orientation, the second opening portion 288 (see FIG. 15) may receive and engage the support body protrusion 160 to lock the hanger rods 116 in place (e.g., substantially parallel to the lengths of conduit 144). As discussed generally above, this adjustability can make pre-fabricated support system significantly easier to transport and install. Generally, an angular offset between a transport orientation and an installation orientation may be 90 degrees (or about 90 degrees), although other configurations are possible.

The support systems discussed herein may thus be prefabricated and installed using improved methods. For example, a connector rod can be inserted through the support passages of select support bodies, to align the support bodies on the connector rod for support of conduit with a predetermined configuration (e.g., as variously discussed above or below). Hanger bodies can also be secured onto the connector rod, including to secure the support bodies together in the desired alignment. Lengths of conduit can be received into conduit passages of the support bodies, including axially aligned sets of conduit in coupler support bodies or pass-through lengths of conduit in spacer support bodies. Specifically, the lengths of conduit may be secured within the conduit passages using conduit fasteners. Hanger rods can also be secured to the hanger bodies (e.g., before or after the hanger bodies are secured to the connector rod). Further, as desired, the hanger bodies can then be rotated relative to the one or more support bodies (e.g., about an axis defined by the connector rod), to selectively orient the hanger rods in a transport orientation (see, e.g., FIG. 16) or an installation orientation (see, e.g., FIG. 14).

Once the pre-fabricated support system is transported to the installation site, the hanger rods may be rotated to the installation orientation (see, e.g., 116A and 116B of FIG. 2) and secured to an overhead building structure. The hanger rods may thereby support the hanger bodies (see, e.g., 120A and 120B of FIG. 2) relative to the building structure. As discussed above, the combination of the hanger rods and hanger bodies may further support the support bodies, arranged between the hanger bodies, via the connector rod, as well as the conduit secured within the support passages of the support bodies. In other configurations, the hanger rods may instead be installed to the building structure, prior to being secured to the hanger bodies.

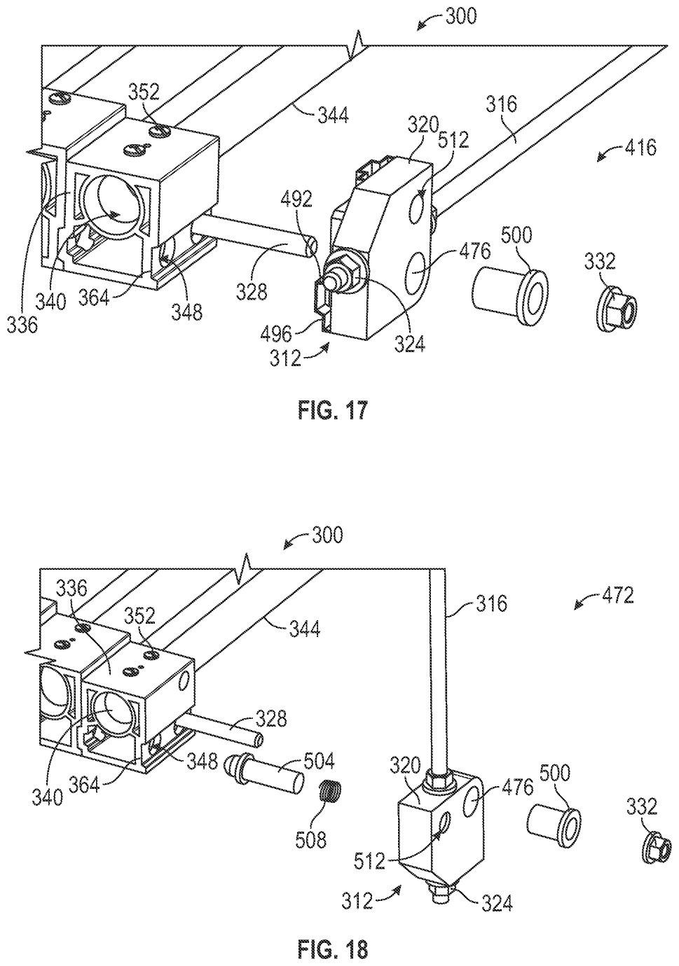

In other examples, other hanger assemblies are possible, including assemblies that are otherwise arranged to move or secure hanger rods relative to installation and transport orientations. For example, FIGS. 17-20 illustrate another example of the hanger assembly 312, with differently configured examples of the hanger body 320 and other related components. In this regard, for example, FIGS. 17-20 illustrate another configuration of a hanger assembly 312. The hanger assembly 312 of FIGS. 17-18 may generally include similar features as the hanger assembly 112 of FIGS. 1-16, including but not limited to a hanger rod 316, a hanger body 320, connector rod fasteners 324, a connector rod 328, connector rod fasteners 332, a support body 336, a support passage 340, conduit 344, conduit fasteners 352, an installation orientation 472, a transport orientation 416, a through-hole 476, hanger rod through-hole (not shown), a first hanger body protrusion 492, and a second hanger body protrusion 496. Thus, discussion of the hanger assembly 112 above also generally applies to similar components of the hanger assembly 312 (and vice versa).

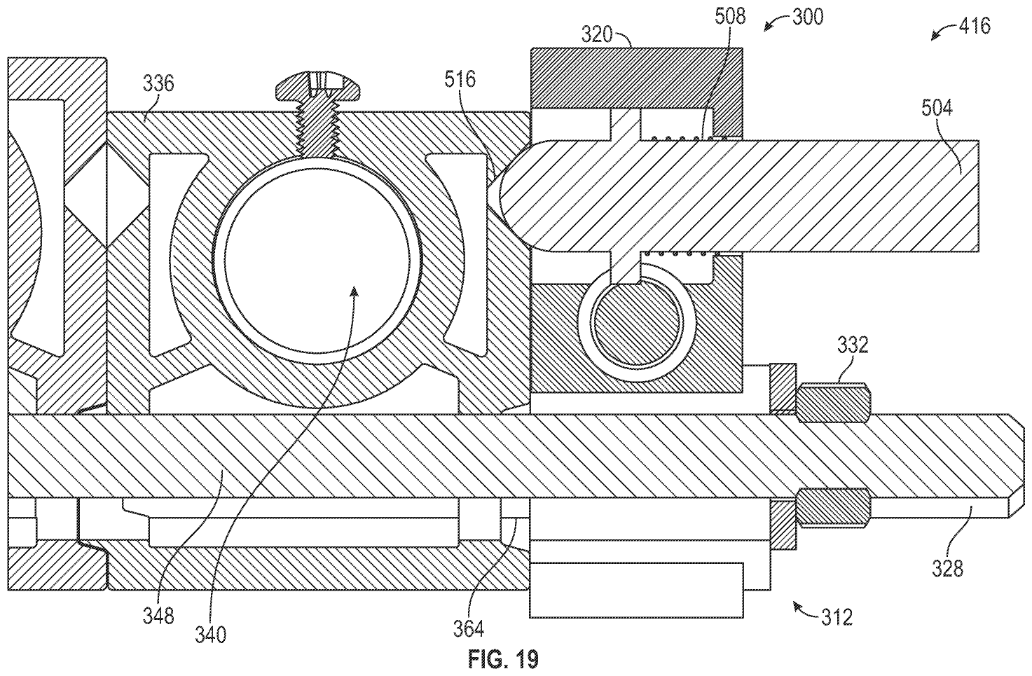

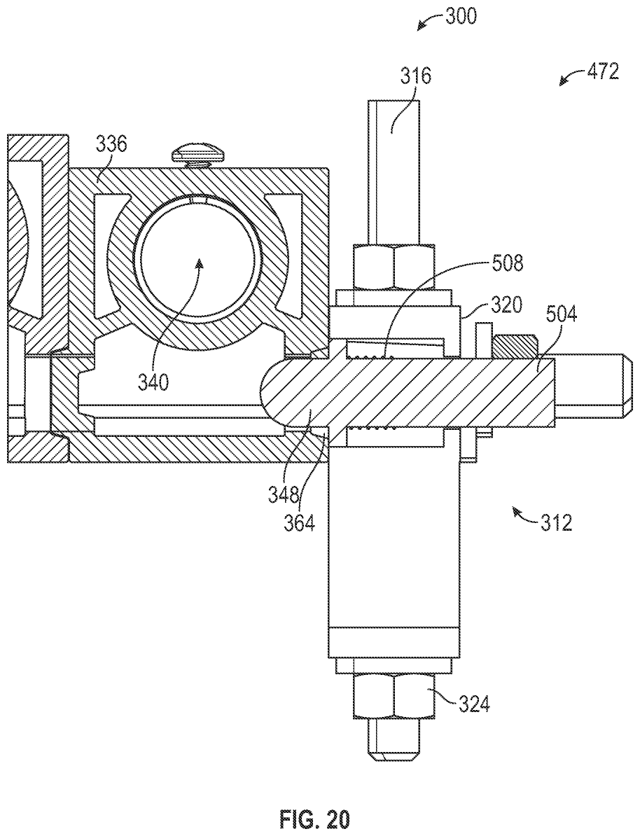

In some aspects, the hanger assembly 112 and 312 may differ. In particular, in addition to the hanger rod through-hole (not shown) and the connector rod through-hole 476, the example hanger assembly 312 further includes a pivot bushing 500. The pivot bushing may be disposed on the connector rod 328 and received into the through-hole 476 (see also FIGS. 19 and 20). In particular, the pivot bushing 500 may thus be configured to support the fastener 332 during tightening. Further, the bushing 500 may be suitably dimensioned to ensure that a small clearance remains between the pivot bushing 500 and the hanger body 320. As further discussed below, this arrangement can allow the hanger body 320 to rotate relative to the adjacent support body 336, even after the fastener 332 is fully tightened (e.g., to transition between transport and installation orientations).

In some example, as also discussed above, protrusions or other features can help to secure a hanger body in a particular orientation. For example, the hanger body 320 may further include hanger body protrusions, configured in particular as a first hanger body protrusion 492 and a second hanger body protrusion 496. The first hanger body protrusion 492 may be configured to engage with the support body opening 364 to secure the hanger assembly 312 in the transport orientation. In contrast, the second hanger body protrusion 496 may be configured to engage with the support body opening 364 to secure the hanger assembly 312 in the installation orientation. In other examples, however, a reversed configuration may be possible, with a similarly configured openings on the hanger body 320 and similarly configured protrusions on the support body 336 (e.g., as generally discussed relative to FIGS. 14-16).

In some cases, the first and second hanger body protrusions 492, 496 can be resiliently deformable protrusions configured to engage a generally complementarily shaped opening. Thus, after a predetermined amount of torque is exerted on the hanger assembly 312, the deformable spring-like material may deform to clear the corresponding opening 164 and thereby allow the hanger assembly 312 to be rotated between the transport orientation and the installation orientation, and vice versa.

The present configuration illustrates alternate locking arrangements that can be used to selectively secure a hanger body at a particular rotational orientation. For example, FIG. 18 illustrates another example of the hanger assembly 312 with the pivot bushing 500, arranged generally similarly to the example of FIG. 17. Further, the example hanger body 320 may include a pin 504 and a resilient member 508 (i.e., a spring, elastomer body, or other component that may naturally tend to return to its original shape after deformation). The resilient member 508 can bias the pin 504 toward the various support bodies 336, so that the pin 504 can act as a detent to prevent rotation of the hanger assembly 312 when suitably engaged. In particular, the pin 504 and the resilient member 508 may be situated in a pin channel 512 in the hanger body 320 adjacent to the bushing 500, although other configurations are possible.

In the present example, while the support system 300 is in the transport orientation 416, the pin 504 may be configured to engage a tapered opening 516 disposed in a sidewall of the support body 136 (as shown in FIG. 19, in particular). This engagement can lock the hanger assembly 312 in the transport orientation 416. During installation, the pin 504 may be moved out of the opening 516 to allow rotation of the hanger assembly 312. In particular, an operator may pull the pin 504 to deform the resilient member 508 and thereby disengage the pin 504 from the tapered opening 516. Or, due to the taper of the opening 516 (or a similar taper on the pin 504), the hanger rod 316 and hanger assembly 312 can simply be rotated by a user with sufficient force to overcome the resilient member 508 and release the pin 504 from the opening 516.

In any case, the hanger assembly 312 may then be rotated fully to the installation orientation. Further, as the hanger assembly 312 is thus rotated, the pin 504 may be configured to further engage the support body 336 to lock the hanger assembly 312 in the installed orientation. For example, as shown in FIG. 20, the pin 504 can engage one of the support passages 348 on the support body 336 to lock the hanger assembly 312 in the installation orientation 472 (although engagement with other features is also possible in some cases). Thereafter, the relative deep insertion of the pin 504 into the support passage 348 (or other feature) can help to avoid inadvertent further orientation changes. However, as needed, the pin 504 may be again moved to deform the resilient member 508 and thereby disengage the pin 504 from the support passage 348 to permit further rotation of the hanger assembly 312 between positions.

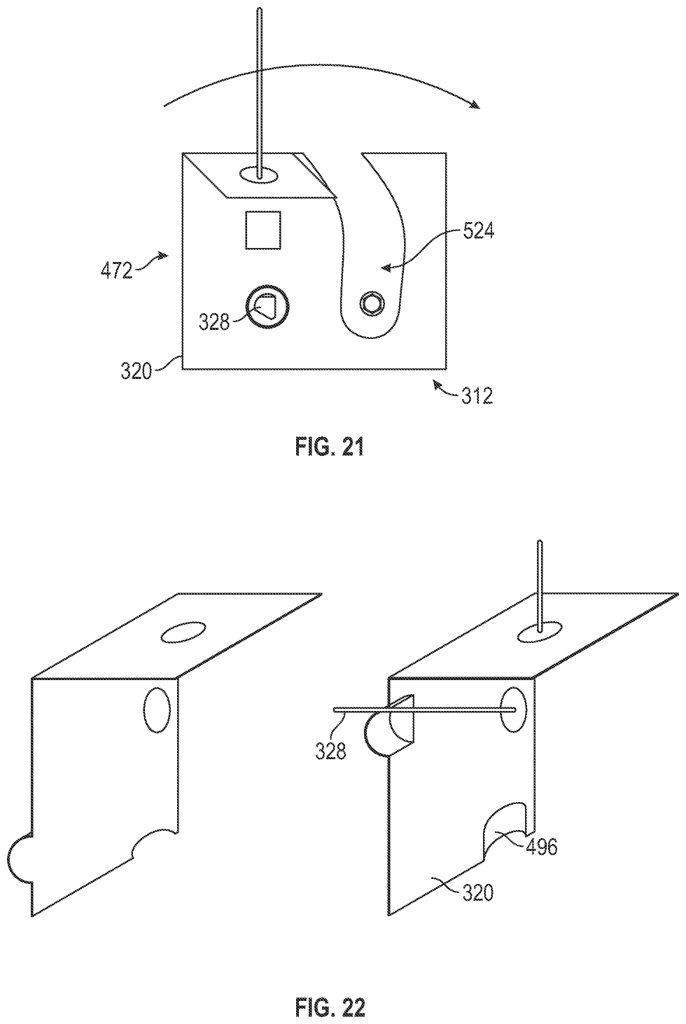

In other examples, other configurations are possible. For example, FIGS. 21 and 22 illustrate additional configurations of the hanger assembly 112 that can in some implementations be formed from stamped sheet metal (or otherwise). In particular, the hanger assembly 312 of FIG. 21 includes an arcuate slot 524 on the hanger body 320 (e.g., formed as a stamped metal body, as generally noted above). The hanger body 320 can thus be rotated (e.g., about the connector rod 328) between installation and transport orientations, with the arcuate slot 524 configured to receive a protrusion from an adjacent support body (e.g., another of the connector rods 328) to accommodate the rotation.

In some examples, detents or other locking formations similar to those discussed above can be provided, including on a sheet metal or other hanger body (e.g., as shown in FIGS. 21 and 22). For example, FIG. 22 illustrates another similar (e.g., sheet metal) configuration of the hanger body 320. In particular, the depicted configuration can include integrally formed examples of the hanger body protrusions 492, 496 to secure the hanger body 320 in the installation and transport orientations, respectively (e.g., similarly to the protrusions 492, 496 discussed relative to FIG. 17).

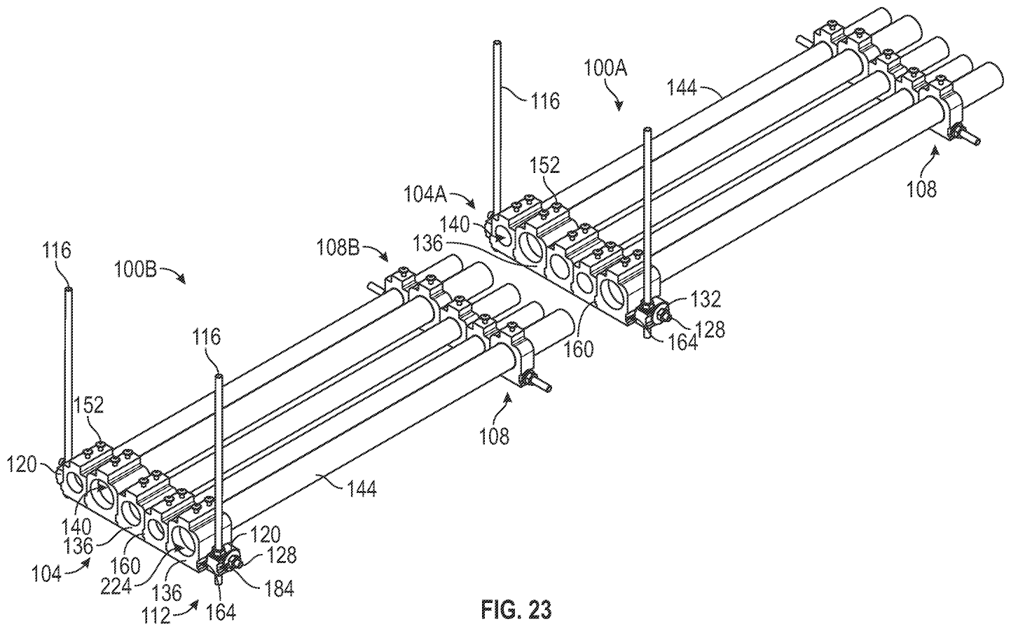

As also noted above, some support systems can be used to axially join sections of conduit together. For example, FIGS. 23 and 24 illustrate the coupling together of two of the support systems 100A, 100B to form an extended run of conduit. With the support systems 100A, 100B secured together into a larger unified support system, as shown in FIG. 24, the hanger rods 116 extend from a first coupler system 104A to support both the first coupler system 104A and a second spacer system 108B of a second of the support systems 100B. Thus, for example, the spacer system(s) 108 may not always require the hanger bodies 120 or the hanger rods 116. However, in another configuration, the coupler systems 104 and the spacer systems 108 may both include respective sets of the hanger rods 116 and the hanger bodies 120.

Thus, to install the illustrated support system 100, a method may include providing a first of the support systems 100A with the hanger assembly 112 in the transport orientation. Once on site for installation, the hanger assembly 112 can be rotated to the installation orientation, and then the hanger rods 116 of the hanger assembly 112A can be secured to the building structure. The second of the support system 100B can then be similarly suspended from building structure, before or after joining the lengths of conduit 144 of the support systems 100A, 100B utilizing the relevant coupler system 104A and spacer system 108B. In this regard, for example, the funneled (or otherwise tapered) configuration of the openings 224 can be helpful in easily aligning the arrayed conduit 144 that extends from the spacer system 108B for insertion into the coupler system 104A.

Generally, the operations of this and other described methods may be performed in any order. For example, the lengths of conduit from the first support system 100A and the second support system 100B may be joined before the hanger assemblies 112 are secured to the building structure. Further, although identical configurations of the two support systems 100A, 100B are shown, similar operations can similarly secure differently configured systems.

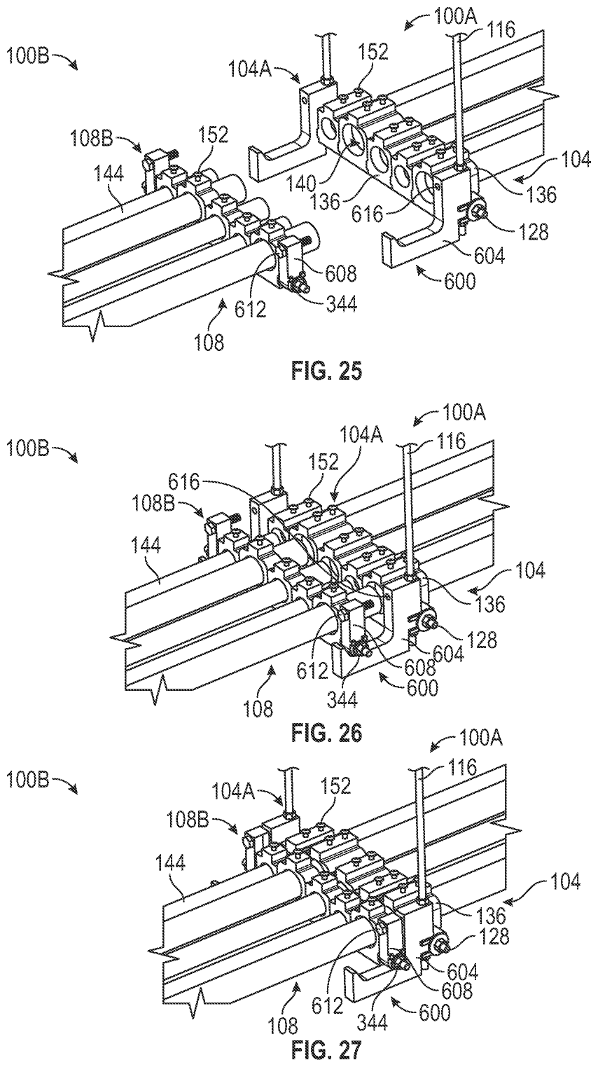

In some examples, assembly guides can be included in the coupler system 104 to facilitate alignment and assembly of the coupler system 104A and the spacer system 108B of the support systems 100A, 100B described above. For example, FIGS. 25-27 illustrate the coupling of the coupler system 104A and the spacer system 108B with the aid of one or more assembly guides 600. The assembly guides 600 may be especially useful for wide assemblies, which may be difficult to maneuver and to support once aligned. In general, the assembly guides 600 may be integrated into particular hanger bodies 120 or may be separate components that may be selectively removable from the coupler system 104A (e.g., for use in assembling another support system).

In particular, the assembly guide 600 in the illustrated example may include an arm 604 that protrudes from the coupler system 104A substantially parallel to the axial direction of the lengths of conduit 144. Correspondingly, the spacer system 108B may include a guide body 608 located on either end of the spacer system 108B. The guide bodies 608 may be integrated into each spacer system 108B or may be separate components that may be selectively removable from the spacer system 108B. In either case, the guide bodies 608 may be received and supported by the corresponding arms 604 of the assembly guides 600 during installation. The guide bodies 608 may then be slid along the arms 604 to maintain a desired alignment of the conduit 144 (and the coupler 104 and spacer systems 108, generally). This can facilitate easy insertion of the lengths of conduit 144 that are coupled to the spacer system 108B into the support bodies 136 of the coupler system 104A.

In some examples, the guide bodies 608 may include one or more threaded guide fasteners 612 that may be configured to be received by guide fastener apertures 616 located on the assembly guide 600. The insertion and subsequent tightening of the guide fasteners 612 may further facilitate the joining of the lengths of conduit 144 that are coupled to the spacer system 108B to the support bodies 136 of the coupler system 104A. In another configuration, the guide bodies 608 may not be included, and the support bodies of the spacer system 108B or the connecting rod thereof may slide directly along the guide arm 604.

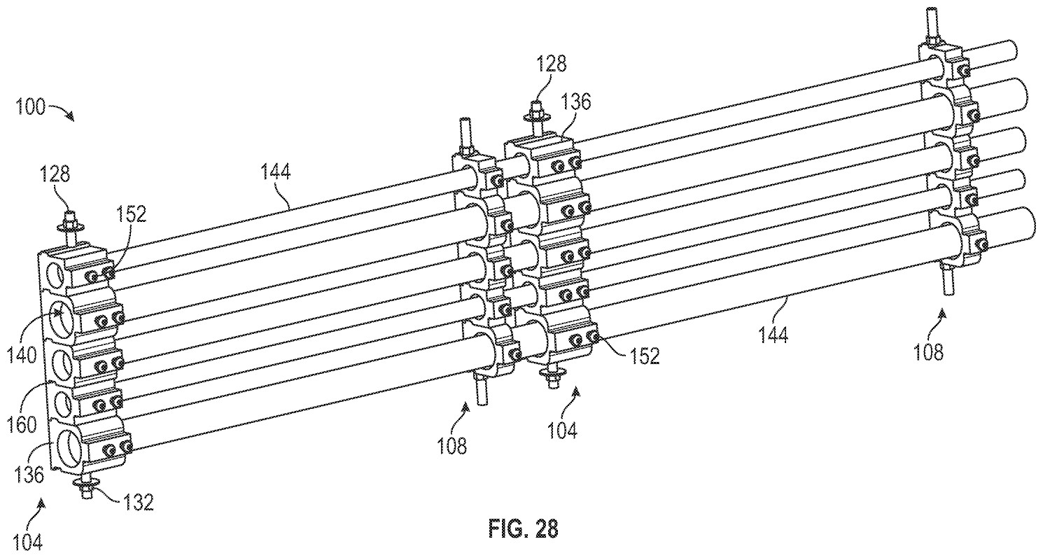

Although generally horizontal installations are discussed above, some examples can be installed in other orientations, including without the use of distinct hanger rods. For example, FIG. 28 depicts the support system 100 installed with the connector rods 128 oriented substantially vertically. Accordingly, for example, the hanger rod 116 and the hanger body 120 can be excluded from the hanger assembly 112, the connector rod 128 can instead be used to hang the support system 100. Or, in some cases, other features on a support body can be engaged with appropriate building structure of fasteners secured thereto (e.g., with key-hole style hanging engagement).

As also generally noted above, in different examples, support bodies can take a variety of forms and can be manufactured in a variety of ways. For example, the preceding discussion and figures generally present support bodies that can be manufactured as generally solid blocks (e.g., using extrusion methods). Once extruded, for example, the support bodies 136 may then further be machined to form the support passage 148, the viewing aperture 220 in the bottom of each support body, one or more of the funneled openings 224, the threaded holes 156, or other features.

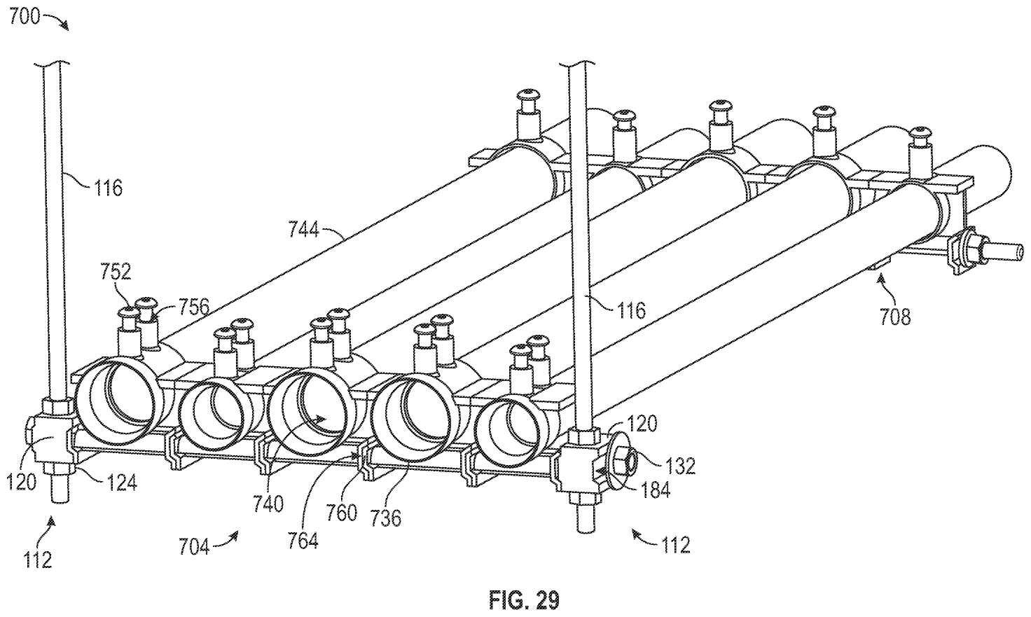

In other examples, other support systems are possible, including with bodies manufactured using die casting. In this regard, for example, FIGS. 29-31 illustrate another configuration of a support system 700. The support system 700 of FIGS. 29-31 may generally include similar features as the support system of FIGS. 1-16, including but not limited to a coupler system 704, a spacer system 708, a hanger assembly 112, support bodies 736 including a conduit passage 740, conduit 744, a support passage 748, conduit fasteners 752, a protrusion 760, and an opening 764. Thus, discussion of the support system 100 above also generally applies to similar components of the support system 700 (and vice versa).

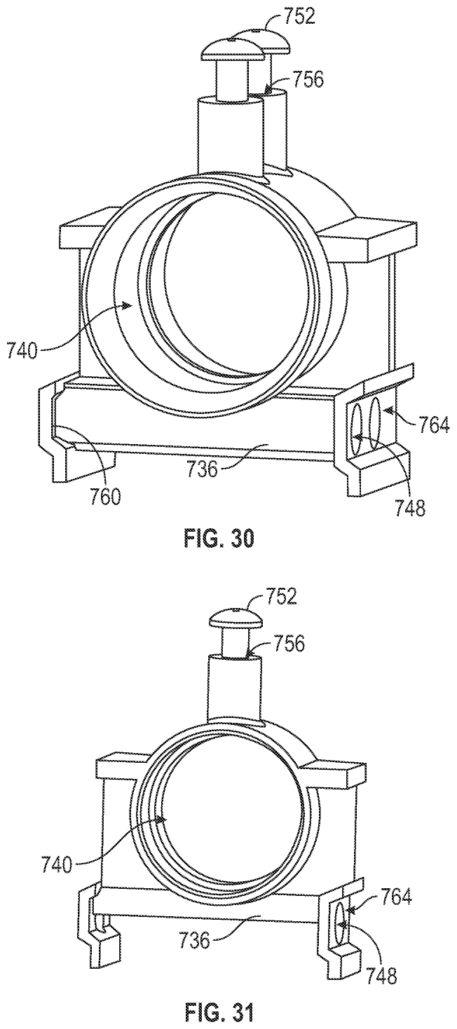

In particular, FIGS. 30 and 31 illustrate detailed views of the example support bodies 136 depicted in FIG. 29, including the support body 736 and a spacer body, respectively. Die casting the support bodies 736 may allow for a reduction in the volume of the non-functional surfaces, potentially allowing the support bodies 736 to use less material, be lighter, and be cheaper to manufacture. For example, the support bodies 736 can be formed with a central barrel and a support web for the passage 740, axially extended lower structures to define the protrusions 760, the openings 764, and the support passages 748, axially extending upper reinforcement flanges, and upper barrel structures to define the threaded holes 756 for the fasteners 752.

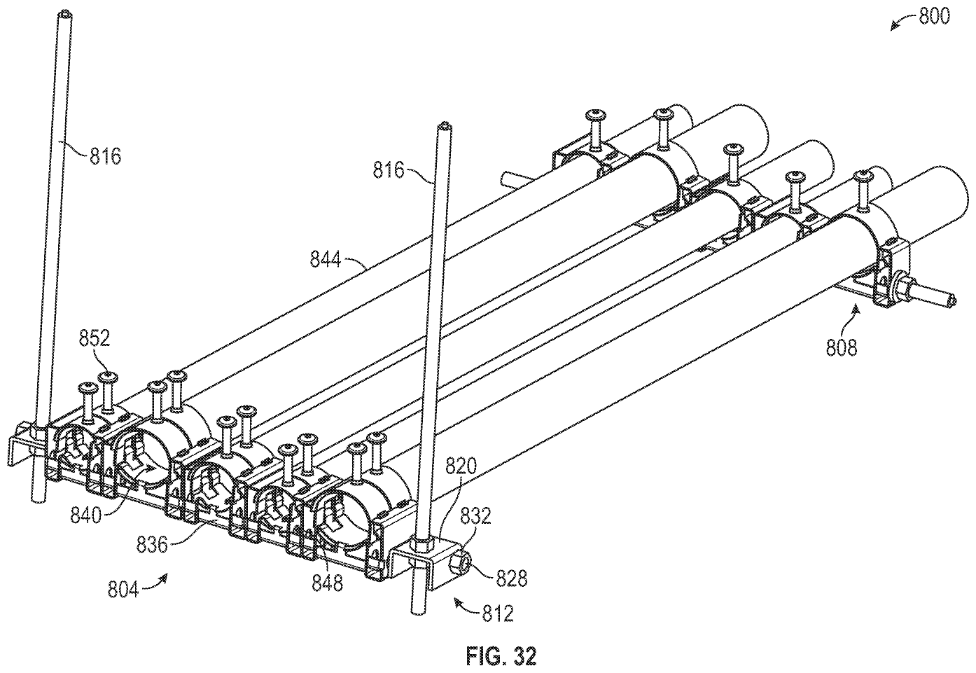

In other examples, other support systems are possible, including with support bodies comprising multiple body pieces. In this regard, for example, FIGS. 32-34 illustrate another configuration of a support system 800. The support system 800 of FIGS. 32-34 may generally include similar features as the support system of FIGS. 1-16, including but not limited to a coupler system 804, a spacer system 808, a hanger assembly 812, hanger rods 816, a connector rod 828, connector rod fasteners 832, spacer bodies, support bodies 836 including a conduit passage 840, conduit 844, a support passage 848, conduit fasteners 852, and threaded holes 856. Thus, discussion of the support system 100 above also generally applies to similar components of the support system 800 (and vice versa).

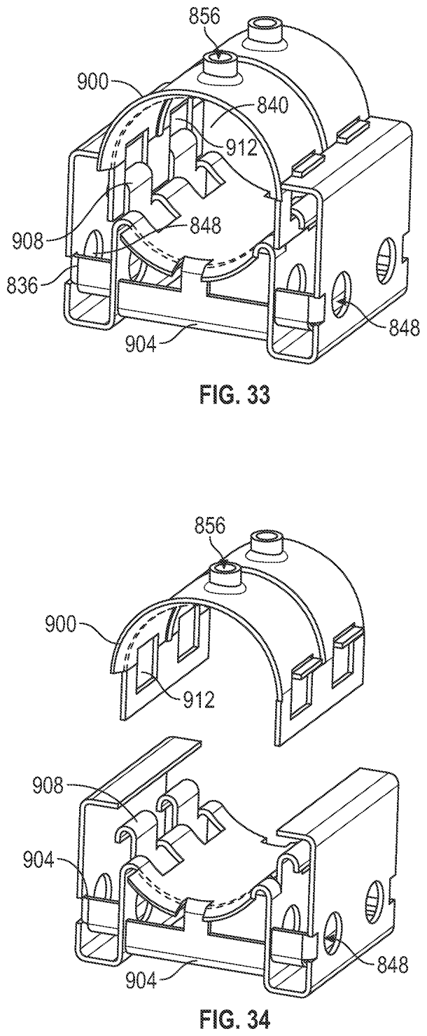

FIG. 32 illustrates an example of the support system 800 with hanger bodies 820 manufactured using stamping. FIGS. 33 and 34 illustrate detailed views of the example support bodies 836 depicted in FIG. 32, configured in particular as a coupler body (although similarly configured spacer bodies are also possible). Stamping the support bodies 836 may allow for a reduction in the volume of the non-functional surfaces, potentially allowing the support bodies 836 to use less material, be lighter, and be cheaper to manufacture. Further, such sheet metal parts may also include additional features, such as bends or folds to prevent the parts from collapsing when the nuts are tightened for the horizontal threaded rod. For example, lateral side portions of the bodies 836 as shown in FIGS. 33 and 34 can include box structures with various cross-supports for rigidity, among other configurations. Similarly, further cross-supports can extend between such lateral side portions as needed (e.g., extending integrally from a conduit-supporting surface, as shown).

As depicted in FIGS. 33 and 34, the stamped support bodies 836 may include an upper body piece 900 and a lower body piece 904 (e.g., each stamped from a respective single piece blank). The upper body piece 900 may be an insertable cover portion, configured to join with the lower body piece 904 to secure conduit therebetween. For example, the lower body piece 904 and upper body piece 900 may have one or more hooks 908 and one or more receptacles 912 for the hooks 908, which can be engaged to hold the support body 836 together.

During prefabrication the use of the upper body piece 900 and the lower body piece 904 may sometimes expedite the assembly of the support system 800. For example, a fabricator can first assemble just the lower body pieces 904 in a desired array on a connector rod, with the lower half of the conduit passage 840 (i.e., on the lower body piece 904) thus aligned and exposed to receive conduit 844. The lengths of conduit 844 can be easily placed onto the open lower body piece 904. Then, the upper body pieces 900 could be inserted over the lengths of conduit 844 and secured onto the lower body piece 904, thus avoiding the need to axially insert the lengths of conduit 844 into the conduit passages 840.

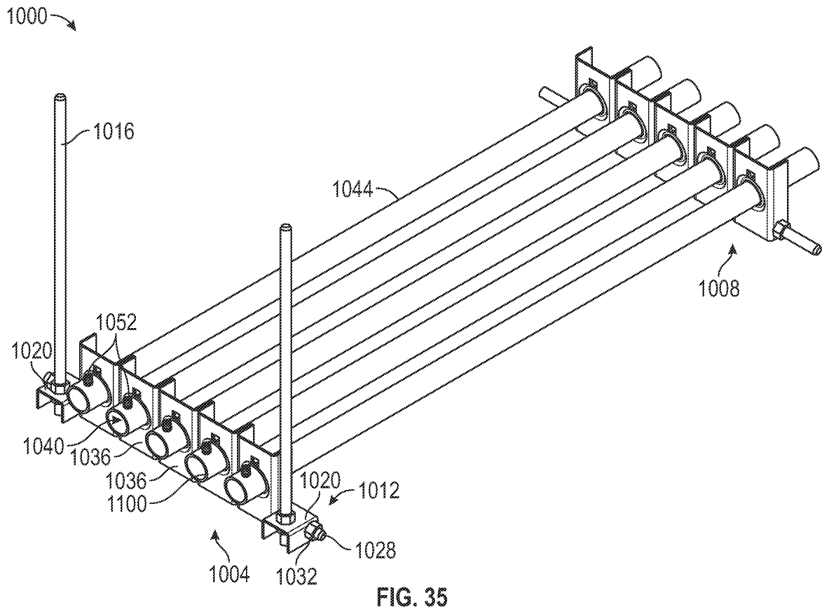

In other examples, other support systems are possible, including stamped from a single sheet of metal. In this regard, for example, FIGS. 35-37 illustrate another configuration of a support system 1000. The support system 1000 of FIGS. 35-37 may generally include similar features as the support system of FIGS. 1-16, including but not limited to a coupler system 1004, a spacer system 1008, a hanger assembly 1012, hanger rods 1016, hanger bodies 1020, a connector rod 1028, connector rod fasteners 1032, spacer bodies, support bodies 1036 including a conduit passage 1040, conduit 1044, a support passage 1048, and a conduit fastener 1052. Thus, discussion of the support system 100 above also generally applies to similar components of the support system 800 (and vice versa).

FIGS. 35-37 illustrate further examples of the support system 1000 as manufactured using stamping. Generally, the example support bodies 1036 shown in FIGS. 35-37 exhibit U-shaped cross-sections, which can allow for relatively simple manufacturing while also providing significant overall strength and allowing appropriate engagement between adjacent support bodies. In other examples, however, other profiles are possible.

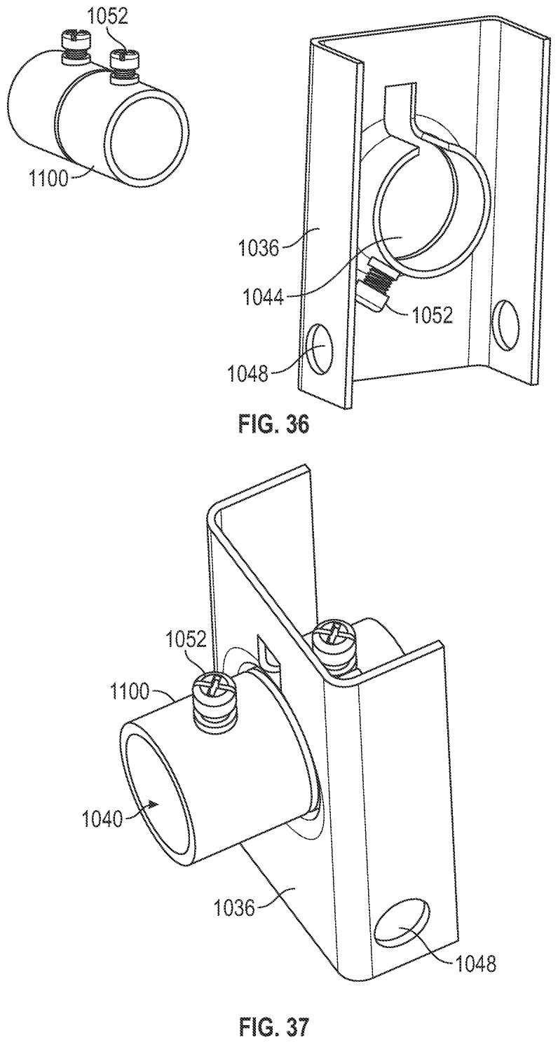

As shown in FIGS. 36 and 37, some examples of the support bodies 1036 of FIG. 35 can accommodate a conduit coupler 1100 (e.g., of conventional or other design). In particular, the example support body 1036 accepts the coupler 1100 into the conduit passage 1040, as defined in this case by an extruded (stamped) collar. The coupler 1100 can then be further secured in place using the conduit fastener 1052 (see FIG. 36).

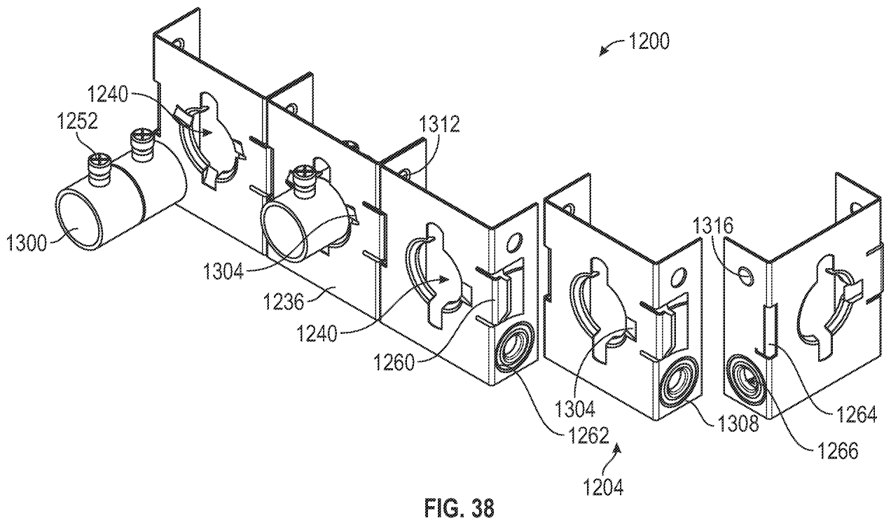

In other examples, other support systems are possible, including alternate stamped support bodies. In this regard, for example, FIGS. 38-40 illustrate another configuration of a support system 1200. The support system 1200 of FIGS. 38-40 may generally include similar features as the support systems 100, 1000 of FIGS. 1-16 and 35-37, including but not limited to a coupler system 1204, a spacer system (not shown), a hanger assembly (not shown), spacer bodies, support bodies 1236 including a conduit passage 1240, a support passage 1248, a conduit fastener 1252, a protrusion 1260, an opening 1264, and a coupler 1300. Thus, discussion of the support system 100 above also generally applies to similar components of the support system 800 (and vice versa).

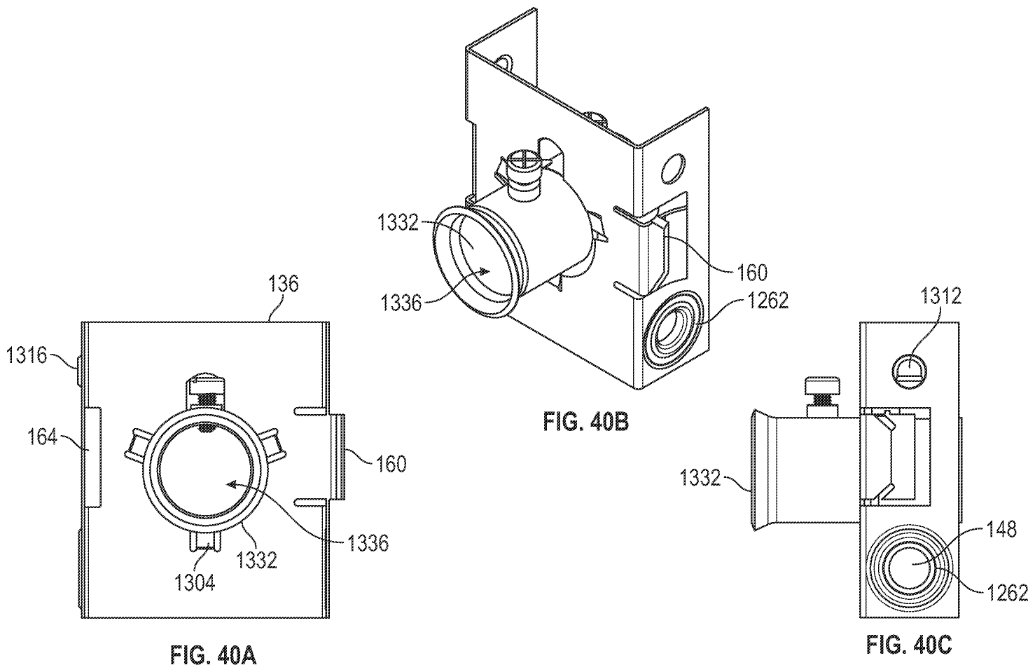

As shown in the example of FIG. 38, some stamped support bodies 1236 can be formed with various additional features to engage conduit, other support bodies, or other components of a support system. For example, the support bodies 1236 as shown may further include one or more spring tabs 1304 that are disposed around the conduit passages 1240 and configured to retain the conduit coupler 1300 (or other component) within the conduit passage 1240. In this regard, as also shown in FIG. 40, the conduit coupler 1300 can be received into the relevant conduit passage 1240 and secured therein by the tabs 1304 (e.g., with the tabs 1304 received into a circumferential waist groove of the coupler 1300). As needed, further devices (e.g., screws) can also be used to further secure the conduit coupler, including as described above.

Also in the present example, as illustrated in FIGS. 38-40 support body protrusions 1260 may be formed as bent tabs, and the support body openings 1264 of the present example are formed as openings that extend entirely through the support body 1236 (e.g., a side wall 1308 thereof). Thus, the support body protrusions 1260 of the present example may be configured to slide into the support body opening 1264 to clip together adjacent support bodies 1236. Further, in some cases, the bent tabs can include barbs (e.g., as shown) that can further engage an adjacent support body 1236 (e.g., at corresponding receiver holes, as shown).

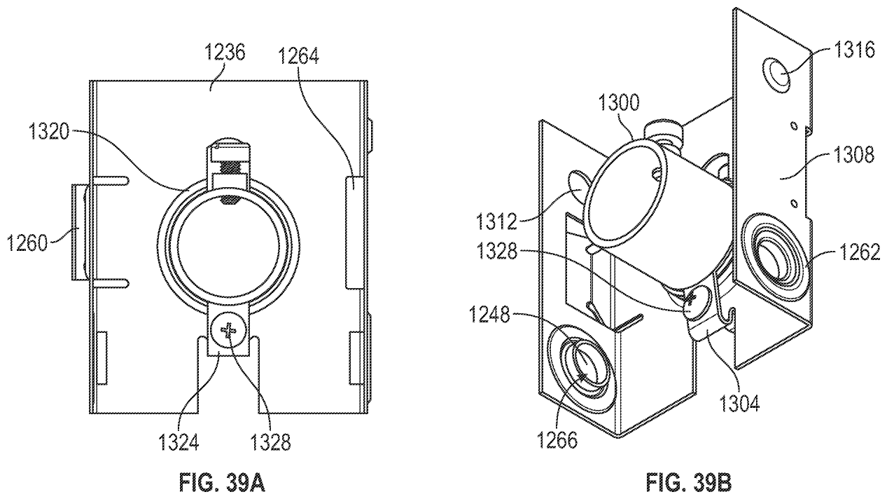

In some cases, other protrusions and openings can be provided. For example, as shown in FIG. 39, the support passage 1248 may include the support passage protrusions 1262 at a first mouth of the support passage, and the support body opening 1264 at a second mouth of the support passage 1248 (e.g., each with an annular profile that surrounds the support passages 1248, as shown). The support passage protrusion 1262 on one of the support bodies 1236 may be configured to engage a support passage opening 1266 opening of support passage 1248 of an adjacent one of the support bodies 1236, and in particular to nest complementarily together in the illustrated example. As also generally discussed above, this engagement between the support passage protrusion 1262 and the support passage opening 1266 may assist in the transfer of shear loading and moment loading across the support system 1200 similar to the support body protrusion 160 and the support body opening 164 described above.

In some cases, as also shown in FIGS. 38 and 39, the support body 1236 may further include a lug hole 1312, and a corresponding protrusion 1316. The lug hole 1312 of one of the support bodies 1236 may be configured to receive the protrusion 1316 of an adjacent support body when the system 1200 is assembled. This engagement between the lug hole 1312 and the protrusion 1316, for example, may assist in the transfer of shear loading and moment loading across the support system 1200 similar to the support body protrusion 160 and the support body opening 164 described above (see, e.g., FIGS. 1-30).

Moreover, as shown in FIG. 39 in particular, further protrusions 1320 can be formed mouths of the support passage (e.g., both formed as extruded features extending inboard of the stamped side walls of the support body 1236). These protrusions 1320 in particular can provide improved strength at a point of engagement with a connector rod (not shown in FIG. 39), with corresponding benefits for the overall strength of the system 1200.

In some examples, in place of or in addition to the spring tabs 1304, a support body can include other features to secure a conduit coupler. For example, as shown in FIG. 39, the example support bodies 1236 may include a retention tab 1324 that can secure the coupler 1300 within the conduit passage 1240 using a corresponding fastener 1328. For example, after the conduit coupler 1300 is received into the support body 1236, the fastener 1328 may be tightened to clamp the coupler 1300 in place. In some examples, a similar feature can be provided to secure conduit couplers (or other objects) in support bodies that also include the spring tabs 1304 (see, e.g., FIG. 38).

As also generally noted above, some examples discussed herein can be include conduit passages with flared openings, to assist in more easily aligning conduit to be secured within the passages. Further this regard, for example, FIG. 40A-C also depicts a conduit coupler 1332 that may include a conduit passage with flared openings 1336 at opposing axial ends thereof. Thus, as similarly discussed above, the coupler 1332 may provide a funneled (or otherwise tapered) entrance profile to assist a prefabricator or installer in guiding the lengths of conduit (not shown) into the coupler 1332 (and the support system 1200 in general).

In other examples, other support systems are possible, including an alternate stamped body. In this regard, for example, FIG. 41 illustrates another configuration of a support system 1400. The support system 1400 of FIG. 41 may generally include similar features as the support system 100 of FIGS. 1-16, including but not limited to a coupler system (not shown), a spacer system (not shown), a hanger assembly (not shown), spacer bodies (not shown), a support body 1436 including a conduit passage 1440, conduit (not shown), and a support passage 1448. Thus, discussion of the support systems 100, 1000, 1200 above also generally applies to similar components of the support system 1400 (and vice versa).

FIG. 41 illustrates another example of the support body 1436 as manufactured using stamping operations. In some cases, the support body 1436 may be formed as an integral body with a relatively simple arrangement of the conduit passage 1440 and the support passage 1448. For example, as shown in FIG. 41, the example support body 136 may include the support passage 1448 formed from a rolled end portion of a single-piece blank, to receive a support rod (not shown), and a conduit passage 1440 that extends through a main, planar portion of the support body 1436 to receive a length of conduit or a conduit coupler (not shown in FIG. 41). The example support body 1436 of FIG. 41 may be stamped cheaply and efficiently from a single piece of sheet metal, and finished with minimal bending. In order to provide further structural support, the example support body 1436 may include a bent top flange 1500, including as can provide improved stiffness against bending movements and help with handling and alignment of the body 1436 generally. In some examples, other features can be provided, including integrally formed protrusions, openings, or other contours to help with alignment and resistance to moments, as variously discussed above.

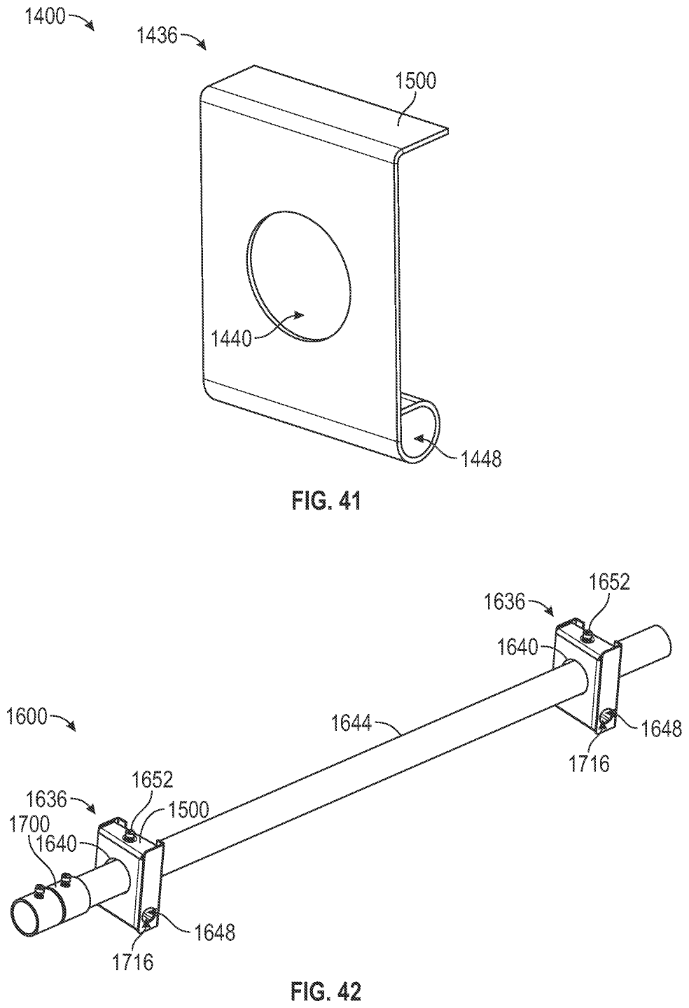

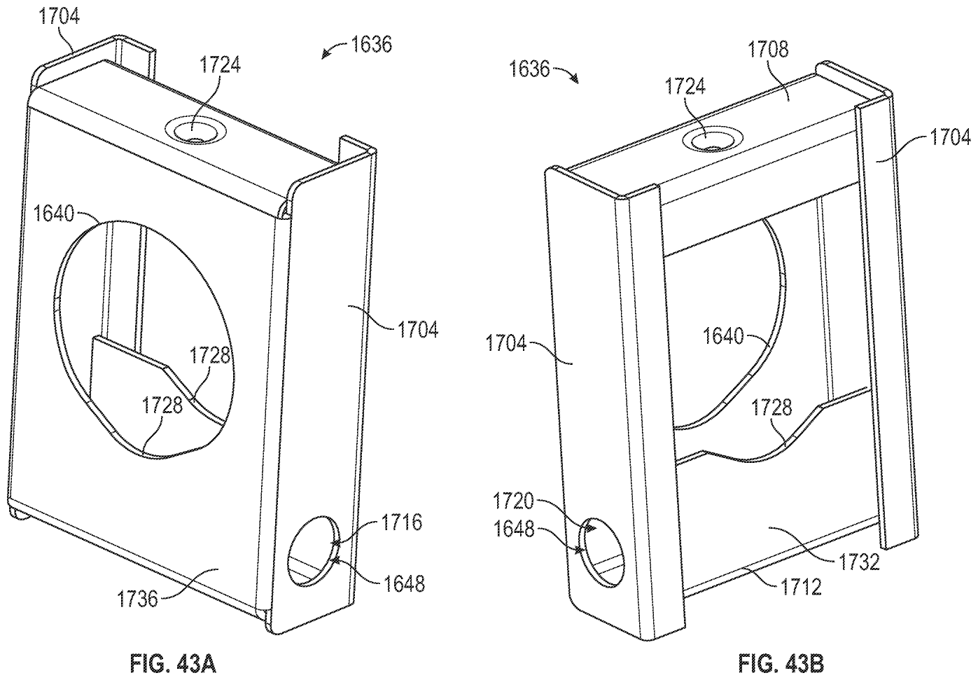

In other examples, other support systems are possible, including an alternate stamped body. In this regard, for example, FIGS. 42-43B illustrate another configuration of a support system 1600. The support system 1600 of FIGS. 42-43B may generally include similar features as the support system 100, 1000, 1200 of FIGS. 1-16, 35-37, and 38-40C and the support system 1600 of FIGS. 42-43B, including but not limited to a coupler system (not shown), a spacer system (not shown), a hanger assembly (not shown), support bodies 1636 including a conduit passage 1640, conduit 1644, a support passage 1648, a conduit fastener 1652, and a coupler 1700. Thus, discussion of the support systems 100, 1000, 1200 above also generally applies to similar components of the support system 1600 (and vice versa).

Generally, the examples shown in FIGS. 42 and 43A-B may be made with relatively simple manufacturing processes, while also providing significant overall strength and allowing appropriate engagement between adjacent support bodies. As shown in FIGS. 43A and 43B in particular, the example support bodies 136 include sidewalls 1704, folded over a first cross wall 1708 and a second cross wall 1712, as integral extensions from a planar front portion that includes the conduit passage 1640. The cross walls 1708, 1712 are themselves also extensions of the front portion, with generally U-shaped profiles to provide improved structural strength for the support body 1636 overall. In other examples, however, other profiles are possible. For example, the sidewalls 1704 may instead fold over the first and second cross walls 1708, 1712.

In some examples, additional (or alternative) features can be included. For example, the sidewalls 1704 can also include a set of openings, including a first opening 1716 and a second opening 1720, to define support passages 1648 for a connector rod (not shown). As further discussed below, one or both of the cross walls 1708, 1712 can include an opening 1724 (e.g., with an extruded threaded portion) to receive a set screw to secure a length of conduit. Further, one or more U-shaped (or other) cutouts 1728 can be included on the front or rear portions of the support body 1636. For example, the cutouts 1728 can be integrally formed with a rear wall 1732 defined by an extension of the cross wall 1712 or as a peripheral contour of the conduit passage 1640 along a front wall 1736.

In some examples, the support bodies 1636 can support a conduit assembly with the conduit coupler 1700 (e.g., of conventional or other design) that is spaced apart from the support bodies 1636. For example, as shown in FIG. 42 in particular, the example support bodies 1636 can receive and support conduit within the conduit passage 1640, as defined in this case by a simple stamped hole, with the conduit coupler 1700 spaced apart from the bodies 1636. Accordingly, a support location for the coupler 1700 may not necessarily be aligned with a location of hanger rods (not shown) to support the support bodies 1636.

In the illustrated example, the conduit itself can be further secured in place using conduit fasteners 1652 (see FIG. 42) received through the openings 1724 (see FIG. 43). For example, the conduit fastener 1652 as shown, may be a self-tapping (or other) screw that is screwed into a top of the first cross wall 1708 (see FIG. 43) to secure the conduit in the conduit passage 1640. In particular, the conduit fastener 1652 may urge the coupler 1700 into the U-shaped cutouts 1728 located in the front wall 1736 and the rear wall 1732 (see FIG. 43), which may be configured to further align and retain the conduit in the conduit passage 1640.

Although the example support body 136 of FIG. 42 is shown as directly supporting the conduit, other configurations are possible. For example, the support body 1636 of FIG. 42 can in some cases receive the conduit coupler 1700 into the conduit passage 1640 (e.g., to be secured by the fastener 1652). As noted above, however, a configuration to engage conduit directly, rather than via a conduit coupler, may allow the relevant support body 1636 to be adaptably positioned at different locations axially along the conduit, providing more flexible installation options.

The example support body 1636 of FIGS. 42 and 43A-B is illustrated without protrusions and corresponding openings as described above (e.g., similar to the protrusions 1262 and the openings 1266). However, in some configurations, the support body 1636 as illustrated in FIGS. 42 and 43A-B can include protrusions or openings to transfer shear load, prevent rotation, or facilitate alignment with other support bodies, as generally discussed above.

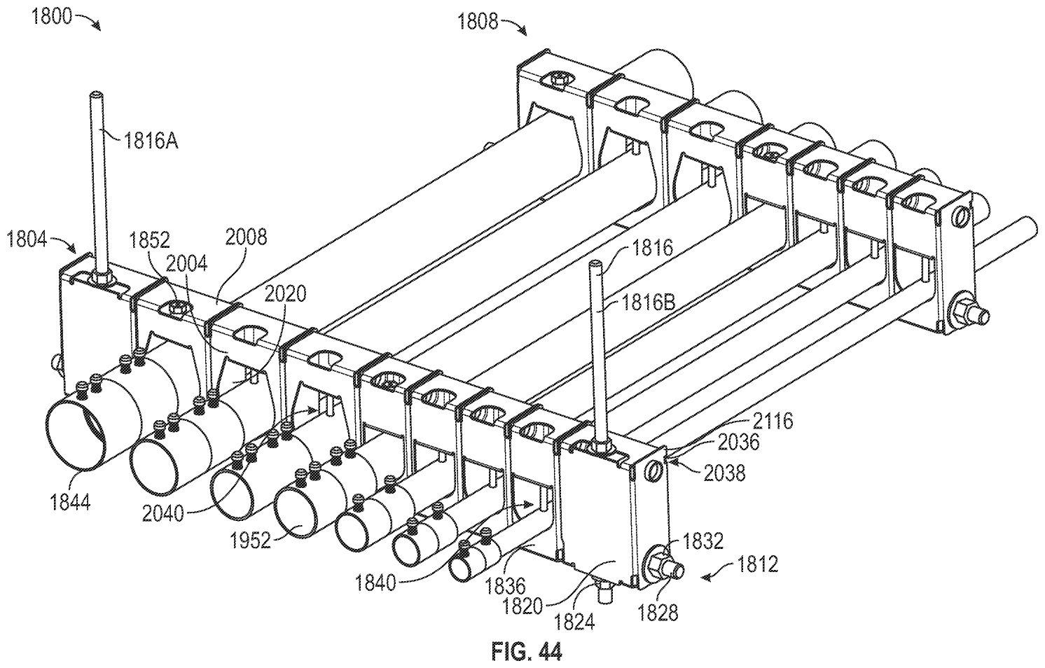

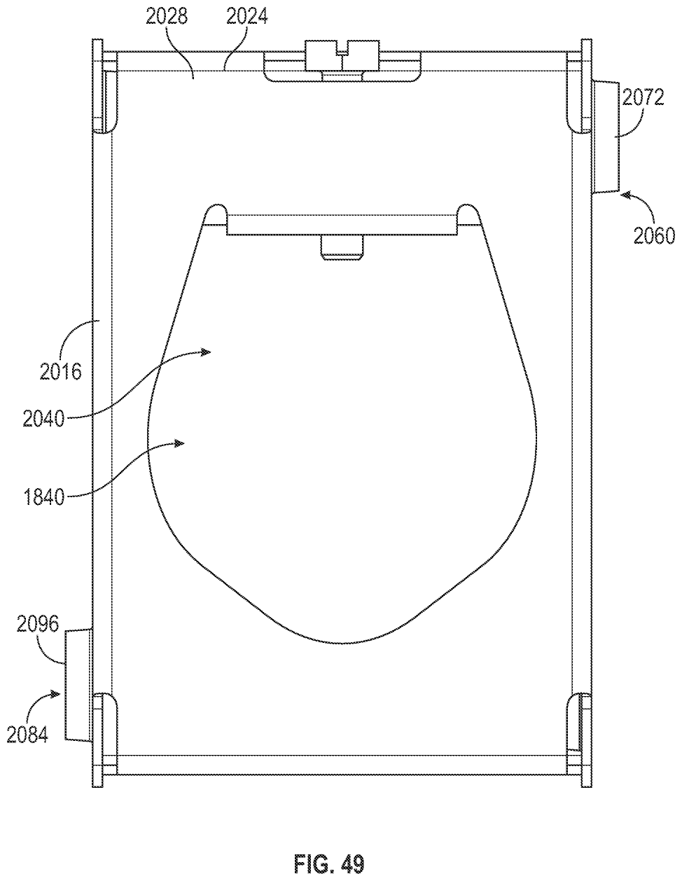

In other examples, other support systems are possible, including an alternate stamped body and hanger assembly system. In this regard, for example, FIGS. 44-60B illustrate another configuration of a support system 1800, arranged for various installations. The support system 1800 of FIGS. 44-60B may generally include similar features as the support systems 100, 1000, 1200, 1600 of FIGS. 1-16, 35-37, 38-40C, and 42-43B, including but not limited to a coupler system 1804, a spacer system 1808, a hanger assembly 1812, hanger rods 1816, hanger bodies 1820, hanger rod fasteners 1824, a connector rod 1828, connector rod fasteners 1832, support bodies 1836 (e.g., first, second, and third support bodies 1836A, 1836B, 1836C) each including a conduit passage 1840, conduit 1844, a support passage 1848, a conduit fastener 1852, protrusions, openings, hanger body protrusions, hanger body openings, a viewing aperture 1920, blank bodies 1948, and a coupler 1952. Thus, discussion of the support systems 100, 1000, 1200, 1600 above also generally applies to similar components of the support system 1800 (and vice versa).

Generally, the examples shown in FIGS. 44-60B may be made with relatively simple manufacturing processes, while also providing significant overall strength and allowing appropriate engagement between adjacent support bodies.

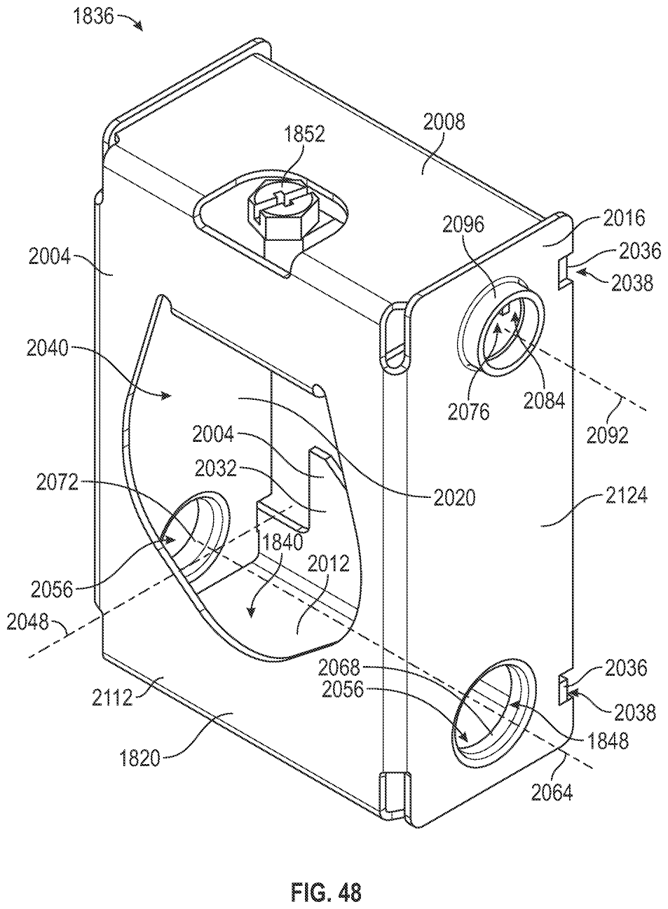

Referring to FIG. 48-51, as similarly discussed above regarding the support body 1636, the support body 1836 may include a front wall 2004, as well as first and second cross-walls 2008, 2012 extending from opposite ends of the front wall 2004. In some configurations, the first cross-wall 2008 may extend substantially parallel to the second cross-wall 2012. The support body 1836 may also include first and second sidewalls 2016, 2020 extending from opposite ends of the front wall 2004. In some configurations, the first sidewall 2016 may extend substantially parallel to the second sidewall 2020, and substantially perpendicular to the first cross-wall 2008. The support body 1836 may additionally include a rear wall 2024, disposed opposite the front wall 2004. In some configurations, the rear wall 2024 may include a first rear wall portion 2028 extending from the first cross-wall 2008 and a second rear wall portion 2032 extending from the second cross-wall 2012.

As illustrated in FIGS. 48-51, the one or more of the cross-walls 2008, 2012 and the sidewalls 2016, 2020 may extend integrally from the front wall 2004. For example, one or more of the cross-walls 2008, 2012 and the sidewalls 2016, 2020 may be integrally connected to the front wall 2004 by a bend. Furthermore, the first and second rear wall portions 2028, 2032 may extend integrally from the first and second cross-walls 2008, 2012 respectively. The first and second rear wall portions 2028, 2032 may further include tabs 2036 that engage recesses 2038 disposed in the sidewalls 2016, 2020. The engagement of the tabs 2036 in the recesses 2038 may aid the securement of the rear wall 2024 and the cross-walls 2008, 2012 to the sidewalls 2016, 2020.

Referring still to FIGS. 48-51, the conduit passage 1840 may extend through the support body 1836, defining a front opening 2040 disposed in the front wall 2004. The front opening 2040 may define a U-Shape and may be configured to receive the conduit 1844 (as illustrated in FIG. 44) into the support body 1836. A conduit axis 2048 may extend through the front opening 2040 substantially perpendicular to the front wall 2004. In some configurations, the conduit passage 1840 may be configured to retain a length of conduit along the conduit axis 2048.

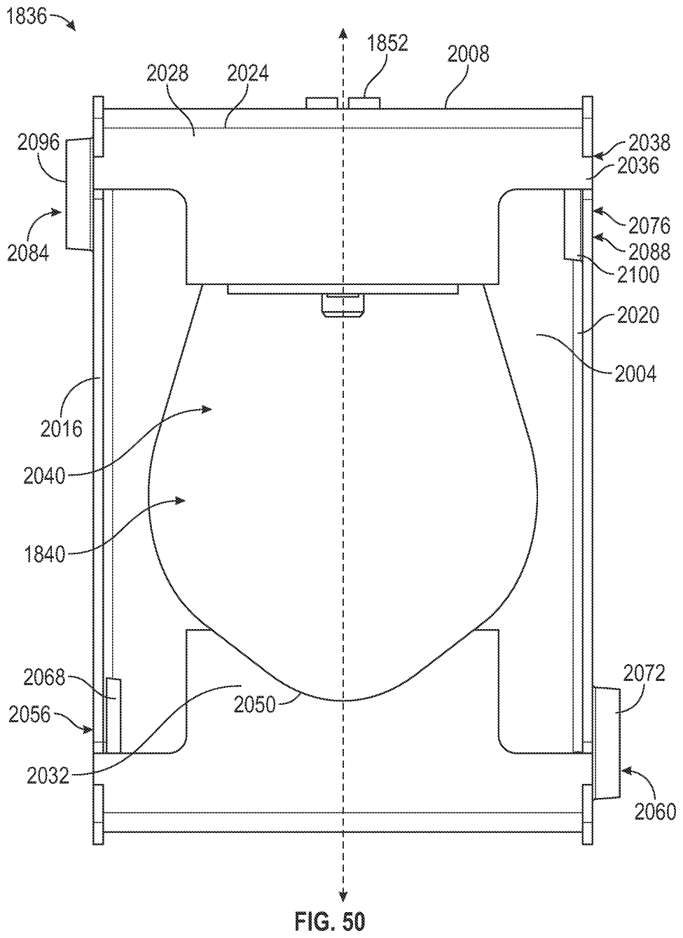

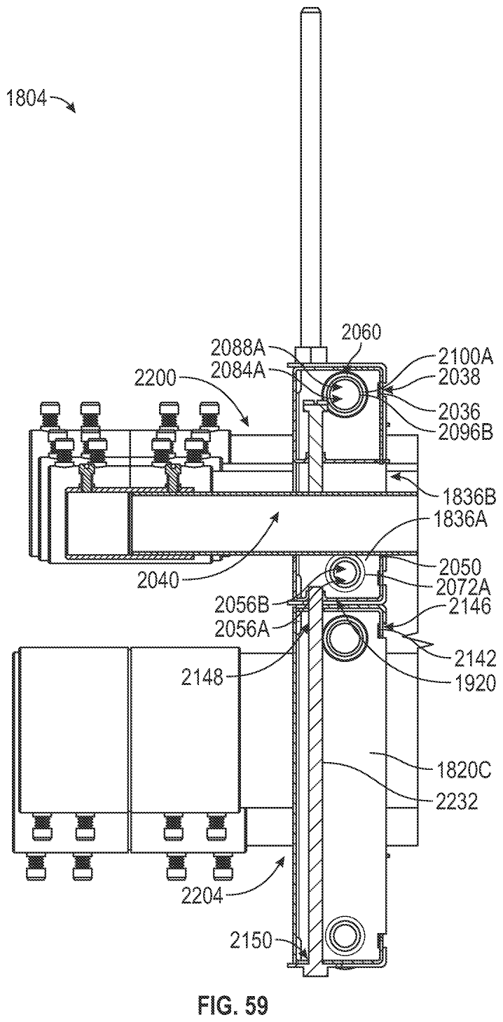

Generally, the rear wall portion 2032 may extend into alignment with the front opening 2040, to help to support conduit received through the opening 2040. As illustrated in FIG. 50, a top edge 2050 of the second rear wall portion 2032 may define a shape that is similar or identical (e.g., geometrically congruent) to at least a portion of the front opening 2040. Referring briefly to FIG. 59, the similar shaped front opening 2040 and top edge 2050 may provide two points of contact to the length of conduit 1844 disposed within the conduit passage 1840 to better support and retain the conduit 1844.

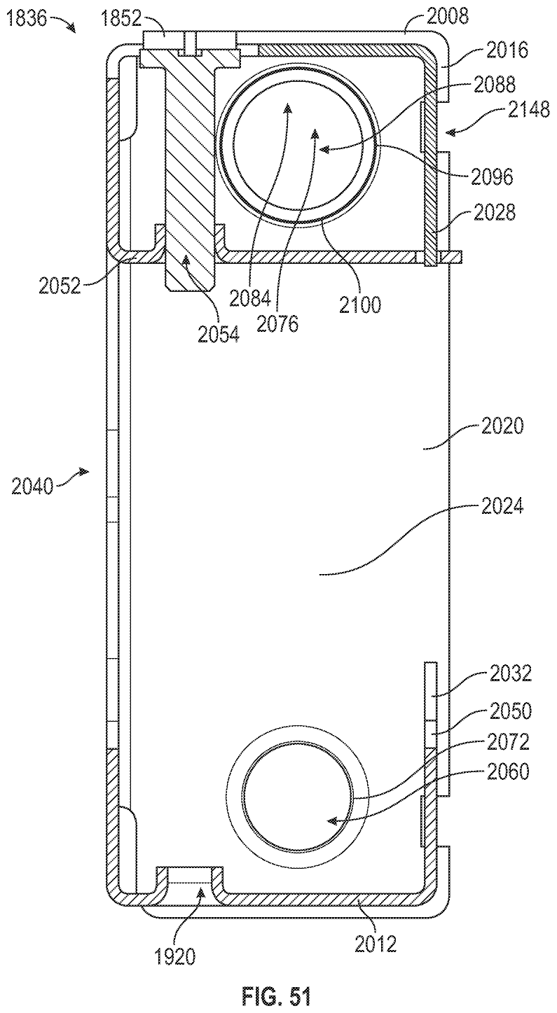

As described above in relation to the support body 136, fasteners may aid the retention of conduit within support passages of the support body. In some examples, a support body can include a recessed support structure that can help to align a fastener to be within the envelope of the support body, rather than protrude beyond the support body (e.g., so as to protrude above a top surface of the support body). Referring specifically to FIG. 51, the support body 1836 may include a third cross-wall 2052 (e.g., a recessed arm), disposed between the first cross-wall 2008 and the front opening 2040. Furthermore, the third cross-wall 2104 may extend integrally and substantially perpendicular from the front wall 2004. The third cross-wall 2052 may include a conduit fastener hole 2054 radially aligned with the conduit axis 2048, configured to receive the conduit fastener 1852. After installation, the conduit fastener 1852 may engage and hold the conduit 1844 (as illustrated in FIG. 44) within the conduit passage 1848.

Still referring to FIG. 51, the support body 1836 may further include the viewing aperture 1920. The viewing aperture 1920 may be disposed in the second cross-wall 2012 radially aligned with the conduit axis 2048. As will be described further below, the viewing aperture 1920 may also be configured to receive a fastener to secure a structure or assembly to the support body 1836.

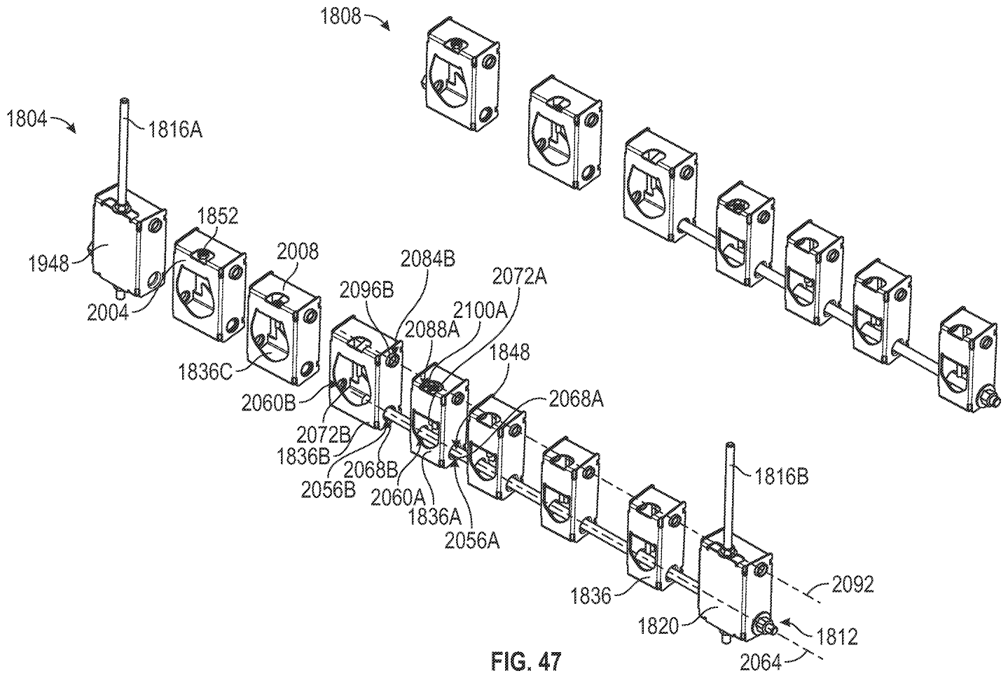

Referring again to FIGS. 48-51, the support passage 1848 may extend through the support body 1836 transverse (e.g., substantially perpendicular) to the conduit passage 1840, and may be configured to receive the connector rod 1828. Similar to the support passage 1248, the support passage 1848 may extend through a first set of openings disposed in the first and second sidewalls 2016, 2020. Specifically, the support passage 1848 may extend from a first support opening 2056 that may be disposed in the first sidewall 2016 to a second support opening 2060 that may be disposed in the second sidewall 2020. A support axis 2064 may extend through a center of the first and second openings 2056, 2060, and may extend substantially perpendicular to the first and second sidewalls 2016, 2020. Referring briefly to FIG. 47, in an installation configuration, the support axis 2064 may extend through a center of the connector rod 1828, and the first and second openings 2056, 2060 may be aligned along the connector rod 1828.

As described above, adjacent support bodies may employ interlocking features to transfer shear between the support bodies. Referring to FIGS. 48 and 50, similar to the protrusions 1262 of the support body 1236, the support body 1836 may include protrusions surrounding the support openings 2056, 2060 of the support passage 1848. More specifically, the first support opening 2056 may include a first support flange 2068 (e.g., a protrusion) that extends axially along the support axis 2064 (see e.g., FIG. 47) from a perimeter of the first support opening 2056 toward the second sidewall 2020. Furthermore, the second support opening 2060 disposed in the second sidewall 2020 may include a second support flange 2072 (e.g., a protrusion) that extends axially along the support axis 2064 (see e.g., FIG. 47) from a perimeter of the second support opening 2060 away from the first sidewall 2016. In some configurations, as further addressed below, an outer diameter of the second support flange 2072 may be less than or substantially similar to an inner diameter of the first support flange 2068 and first support opening 2056. In some examples, flanges (e.g., protrusions) discussed herein, may surround an entire perimeter of an opening. However, in some configurations, the flanges may be discontinuous or may circumscribe less than an entire perimeter of the opening.

Referring to FIG. 47, the first support body 1836A may include a first support flange 2068A and a second support flange 2072A extending from a first and second support opening 2056A, 2060A respectively. Furthermore, the second support body 1836B may include a third support flange 2068B and a fourth support flange 2072B extending from a third and fourth support opening 2056B, 2060B respectively. As illustrated in FIG. 47, the first, second, third, and fourth support flanges 2068A, 2072A, 2068B, 2072B may be aligned on the support axis 2064, and therefore the connector rod 1828. After installation the second support flange 2072A of the first support body 1836A may extend into the third support opening 2056B and engage the third support flange 2068B of the second support body 1836B to transfer shear between the support bodies 1836A, 1836B.

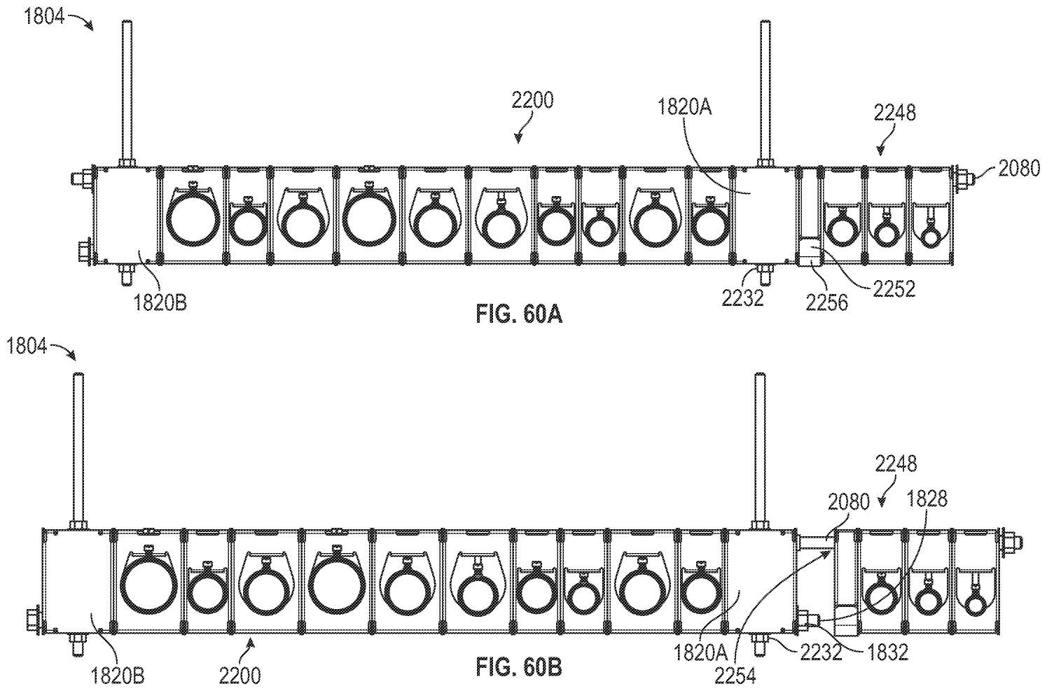

Referring again to FIGS. 48-51, an extension passage 2076 (e.g., a second support passage substantially similar to the support passage 1848), configured to receive an extension rod 2080 (e.g., a second connector rod, as illustrated in FIG. 60A and discussed further below), may extend through the support body 1836 transverse (e.g., substantially perpendicular) to the conduit passage 1840. Similar to the support passage 1848, the extension passage 2076 may extend through a second set of openings disposed in the first and second sidewalls 2016, 2020. Specifically, the extension passage 2076 may extend from a first extension opening 2084 that may be disposed in the first sidewall 2016 to a second extension opening 2088 that may be disposed in the second sidewall 2020. An extension axis 2092 may extend through a center of the first and second extension openings 2084, 2088, and may extend perpendicular to the first and second sidewalls 2016, 2020.

Similar to the support openings, the extension openings of adjacent support bodies may employ interlocking features to transfer shear between the support bodies. Referring to FIGS. 48 and 50, similar to the first and second support openings 2056, 2060 of the support passage 1848, the extension passage 2076 may include protrusions surrounding the first and second extension openings 2084, 2088. Specifically, the first extension opening 2084 may include a first extension flange 2096 (e.g., a protrusion) that extends axially along the extension axis 2092 (see e.g., FIG. 47) from a perimeter of the first extension opening 2084 away from the second sidewall 2020. Furthermore, the second extension opening 2088 may include the second extension flange 2100 (e.g., a protrusion) that extends axially along the extension axis 2092 (see e.g., FIG. 47) from a perimeter of the second extension opening 2088 toward the first sidewall 2016. In some configurations, as will become apparent below, an outer diameter of the first extension flange 2096 may be less than or substantially similar to an inner diameter of the second extension flange 2100 and the second extension opening 2088.

Referring briefly to the cross-section of FIG. 59, after installation a third extension flange 2096B, extending from a third extension opening 2084B of the second support body 1836B may extend into a second extension opening 2088A and engage the second extension flange 2100A of the first support body 1836A to transfer shear between the support bodies 1836A, 1836B. The above-described interaction may further lock the first and second support bodies 1836A, 1836B against rotation relative to one another. In some examples, a first extension flange (not shown), extending from a first extension opening (not shown) of the support body 1836A may extend into a fifth extension opening (not shown) and engage a fifth extension flange (not shown) of a third support body 1836C to transfer shear between the support bodies 1836A, 1836C.

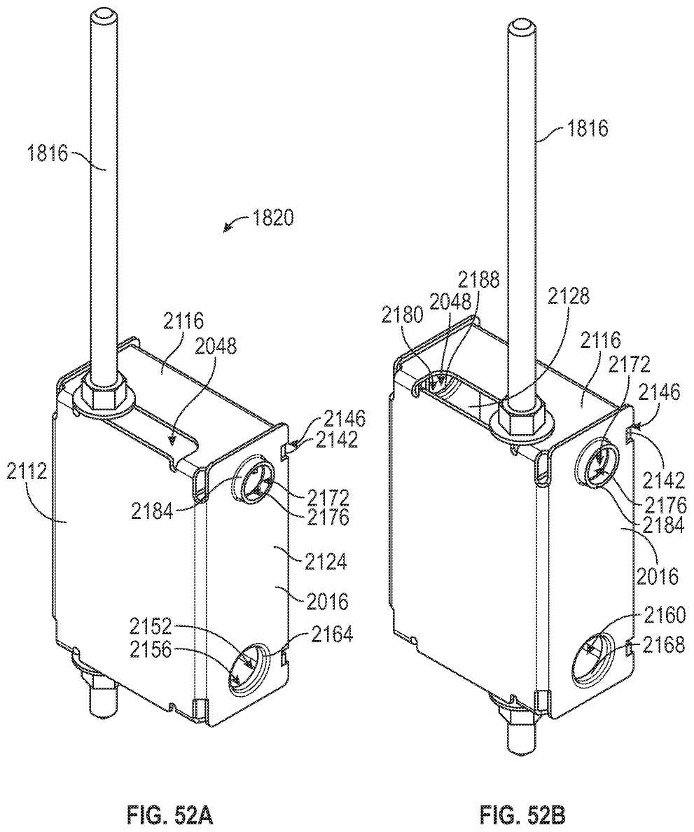

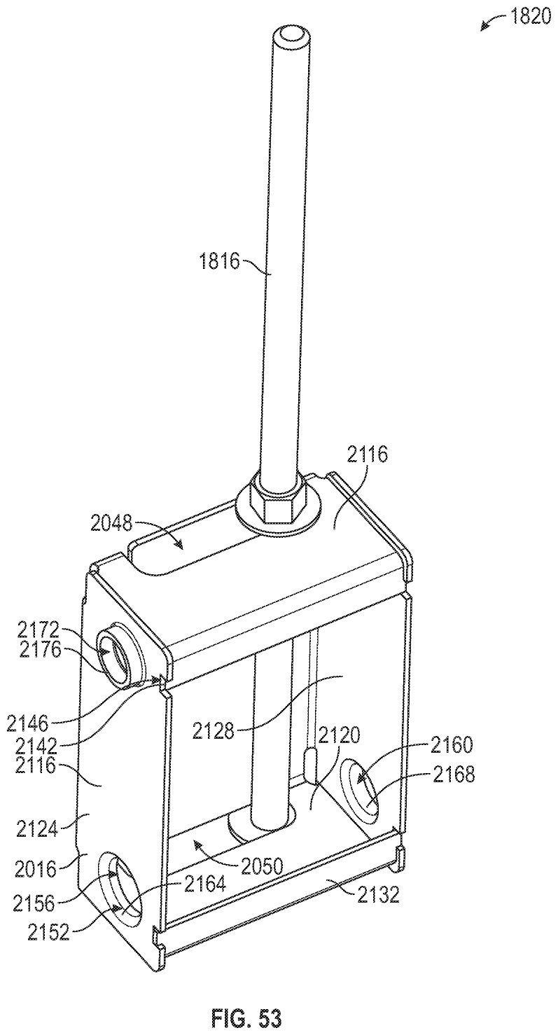

Referring to FIGS. 52A-53, similar to the support body 1836, the hanger body 1820 may include a front hanger wall 2112, as well as first and second hanger cross-walls 2116, 2120 extending substantially in parallel from opposite ends of the front hanger wall 2112. The hanger body 1820 may also include first and second hanger sidewalls 2124, 2128 extending substantially in parallel from opposite ends of the front hanger wall 2112. The first and second hanger sidewalls 2124, 2128 may further extend substantially perpendicular to the first hanger cross-wall 2116. Additionally, the hanger body 1820 may include a rear hanger wall 2132, similar to the rear wall 2024.

As illustrated in FIGS. 52A-53, similar to the support body 1836, one or more of the hanger cross-walls 2116, 2120 and the hanger sidewalls 2124, 2128 may extend integrally from the front hanger wall 2112. For example, one or more of the hanger cross-walls 2116, 2120 and the hanger sidewalls 2124, 2128 may be integrally connected to the front hanger wall 2112 by a bend. Similar to the rear wall 2024, the rear hanger wall 2132 may include hanger tabs 2142 that engage hanger recesses 2146 disposed in the hanger sidewalls 2124, 2128. The engagement of the hanger tabs 2142 in the hanger recesses 2146 may aid the securement of the hanger cross-walls 2116, 2120 to the sidewalls 2124, 2128.

Referring still to FIGS. 52A-53, the first and second hanger cross-walls 2116, 2120 may each include an elongate slot. Specifically, as illustrated in FIG. 53, the first hanger cross-wall 2116 may include a first slot 2148 and the second hanger cross-wall 2120 may include a second slot 2150. The first and second slots 2148, 2150 may be aligned (e.g., along a common vertical plane), and may be configured to receive the hanger rod 1816. As illustrated in FIG. 44, in an installed configuration, the first and second slots 2148, 2150 may extend—and correspondingly allow movement of the hanger rod 1816—substantially parallel to the support axis 2064. Correspondingly, the slots 2148, 2150 may also extend substantially parallel to the connector rod 1828.

During installation, the hanger rod 1816 may be slidable along the first and second slots 2148, 2150. For example, as illustrated in FIGS. 52A and 52B, the hanger rod 1816 may be tightened and installed anywhere along the first and second slots 2148, 2150. The adjustability of the hanger rod 1816 within the first and second slots 2148, 2150 may advantageously allow the coupler system 1804 to be installed to hang from walls, ceilings, support beams, and other structures that are a variable distance apart. As discussed further below, the adjustability of the hanger rod 1816 within the first and second slots 2148, 2140 may also advantageously allow the coupler system 1804 to be shifted axially relative to the support axis 2064 (as illustrated in FIG. 44) to account for any alignment issues of the conduit 1844 or of the coupler system 1804 in general.

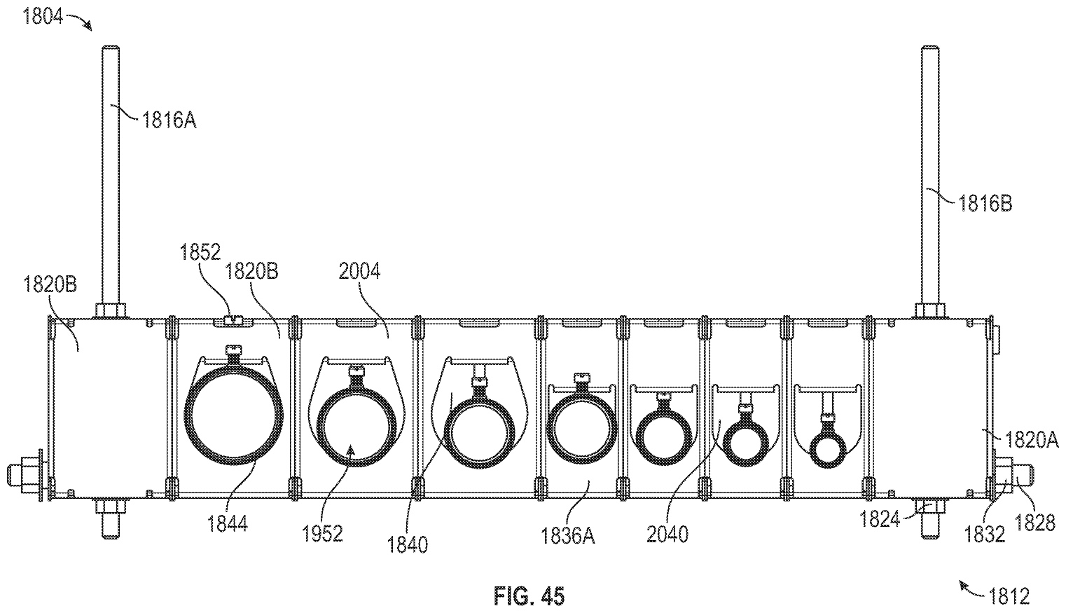

Referring to FIGS. 52A-53, a hanger support passage 2152 may extend through the hanger body 1820, and may be configured to receive the connector rod 1828. Furthermore, the hanger support passage 2152 may extend through a first set of hanger openings disposed in the first and second hanger sidewalls 2124, 2128. Specifically, the hanger support passage 2152 may extend from a first hanger opening 2156 that may be disposed in the first hanger sidewall 2124 to a second hanger opening 2160 that may be disposed in the second hanger sidewall 2128. As illustrated in FIG. 45, in an installed configuration of the coupler system 1804, the support axis 2064 may extend through a center of the first and second hanger openings 2156, 2160, and may extend perpendicular to the first and second hanger sidewalls 2124, 2128.

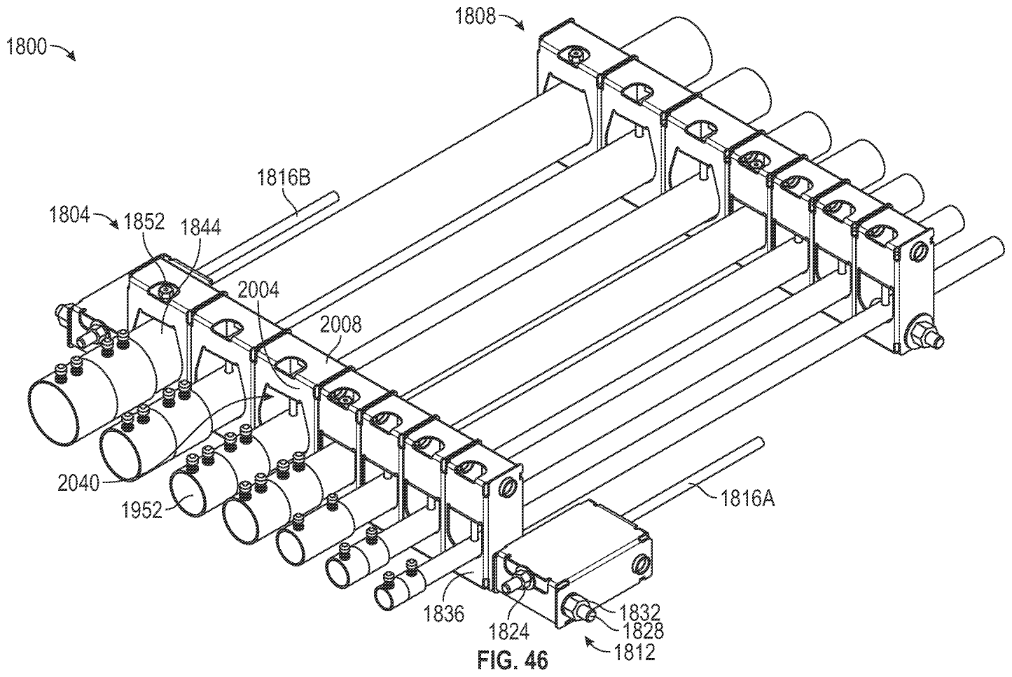

Similar to the hanger body 120, the hanger body 1820 can be rotated relative to the support body 1836 (e.g., about the connector rod 1828), to selectively orient the hanger rods in a transport orientation (see, e.g., FIG. 46) or an installation orientation (see, e.g., FIG. 44).

As described above, hanger bodies may employ interlocking features to transfer shear between hanger bodies and adjacent support bodies. Referring to FIGS. 52A-53, similar to the first and second support openings 2056, 2060 of the support passage 1848, the hanger support passage 2152 may include protrusions surrounding the first and second hanger openings 2156, 2160. More specifically, the first hanger opening 2156 may include a first hanger flange 2164 (e.g., a protrusion) that extends axially along the support axis 2064 (see e.g., FIG. 47) from a perimeter of the first hanger opening 2156 toward the second hanger sidewall 2128. Additionally, the second hanger opening 2160 may include a second hanger flange 2168 (e.g., a protrusion) that extends axially along the support axis 2064 (see e.g., FIG. 47) from a perimeter of the second hanger opening 2160 away from the first hanger sidewall 2124. In some configurations, as will become apparent below, an outer diameter of the second hanger flange 2168 may be less than or substantially similar to an inner diameter of the first support flange 2068 and first support opening 2056 of the support body 1836.

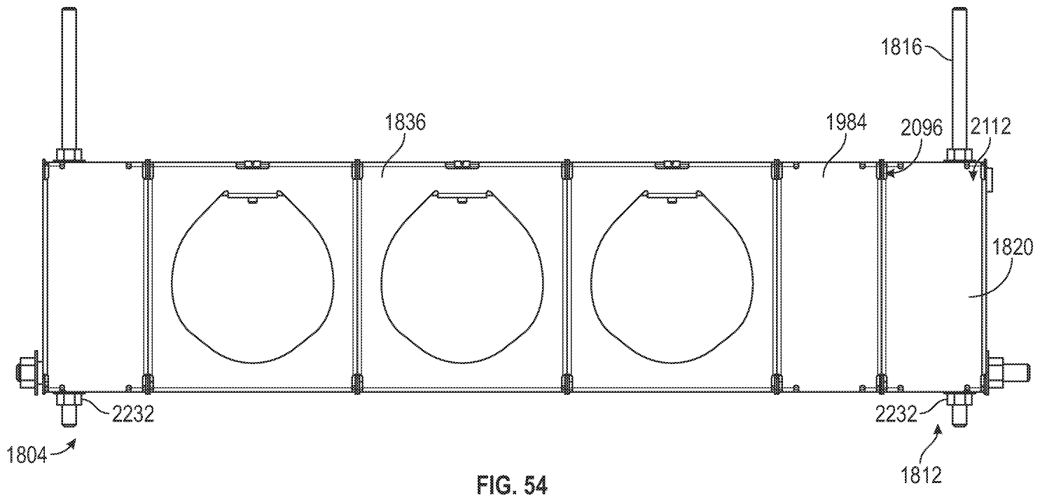

Referring to FIG. 47, the first and second support flanges 2068, 2072 and the first and second hanger flanges 2164, 2168 may be aligned on the support axis 2064, and therefore along the connector rod 1828. Similar to the interaction of the first and second support bodies 1836A, 1836B described above, after installation the second hanger flange 2168 may extend into the first support opening 2056 and engage the first support flange 2068 of the support body 1836 to transfer shear between the support body 1836 and the hanger body 1820. Though not described in further detail herein, a similar shear transfer interaction could occur between the first support flange 2164 and the second hanger opening 2160. Likewise, a similar shear transfer interaction could occur between two hanger bodies as illustrated in FIG. 54, via interaction between respective first and second hanger body openings and flanges.

Referring again to FIGS. 52A-53, a hanger extension passage 2172, configured to receive the extension rod 2080 (illustrated in FIG. 60A and discussed further below), may extend through the hanger 1820. Furthermore, the hanger extension passage 2172 may extend through a second set of openings disposed in the first and second hanger sidewalls 2124, 2128. Specifically, the extension passage 2172 may extend from a first hanger extension opening 2176 that may be disposed in the first hanger sidewall 2124 to a second hanger extension opening 2180 that may be disposed in the second hanger sidewall 2128. As illustrated in FIG. 45, in an installed configuration of the coupler system 1804, the extension axis 2092 may extend through a center of the first and second hanger extension openings 2176, 2180, and may extend perpendicular to the first and second hanger sidewalls 2124, 2128.

Similar to the hanger openings, the extension hanger openings of the hanger bodies may employ interlocking features (e.g., openings and protrusions) to transfer shear between the hanger bodies and adjacent hanger or support bodies. Referring to FIGS. 52A-53, the first hanger extension opening 2176 may include a first hanger extension flange 2184 (e.g., protrusion) that extends axially along the extension axis 2092 (see e.g., FIG. 47) from a perimeter of the first hanger extension opening 2176 away from the second hanger sidewall 2128. Furthermore, the second hanger extension opening 2180 may include a second hanger extension flange 2188 (e.g., a protrusion) that extends axially along the extension axis (see e.g., FIG. 47) from a perimeter of the second hanger opening 2160 toward the first hanger sidewall 2124. In some configurations, as will become apparent below, an outer diameter of the first hanger extension flange 2184 may be less than or substantially similar to an inner diameter of the second extension flange 2100 and the second extension opening 2084 of the support body 1836.

Referring to FIG. 47, the first and second extension opening 2084, 2088 and the first and second hanger extension openings 2176, 2180 may be aligned on the extension axis 2092 of the support body 1836. Similar to the interaction of the first and second support bodies 1836A, 1836B described above, after installation the first extension flange 2096 of the first extension opening 2084 may extend into the second hanger extension opening 2180 and engage the second hanger extension flange 2188 to transfer shear between the support body 1836 and the hanger body 1820. The above-described interaction, may further lock the support body 1836 and the hanger body 1820 against rotation relative to one another. Though not described in detail herein, a similar shear transfer interaction could occur between the second extension flange 2100 and the first hanger extension opening 2176. Likewise, a similar shear transfer interaction could occur between two hanger bodies as illustrated in FIG. 54, via interaction between respective first and second hanger body extension openings and flanges.

Referring to FIG. 54, as described above, in some configurations the support system 1800 may include one or more blank bodies 1948 (or spacer bodies). As illustrated in the present example, one of the hanger bodies 1820 can be used as the blank body 1984 to occupy space and provide structural stability, while not necessarily receiving a length of conduit

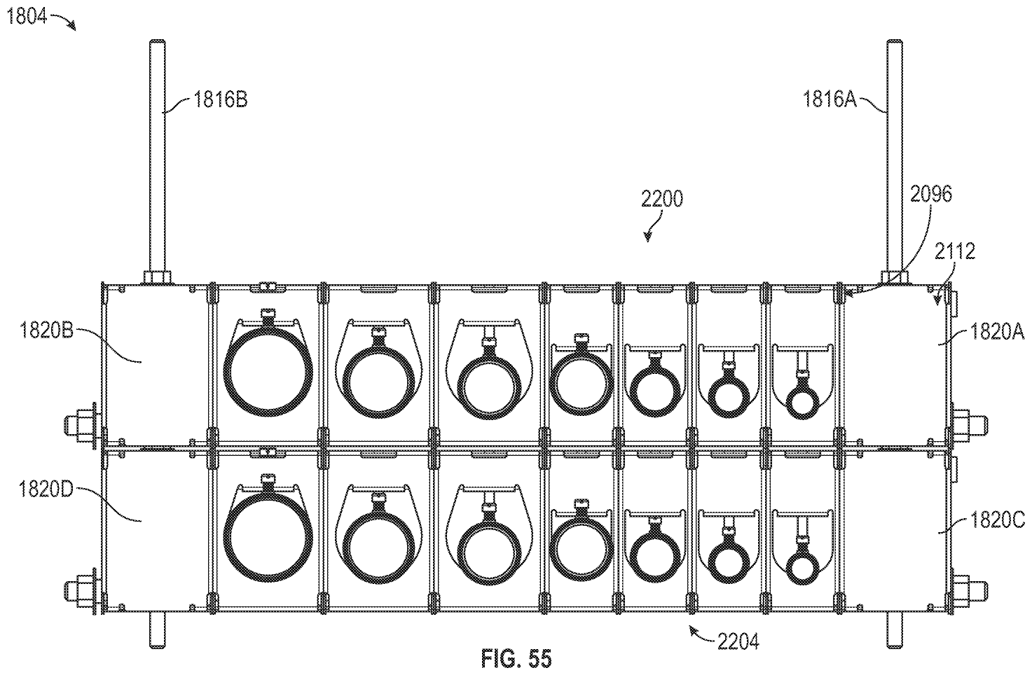

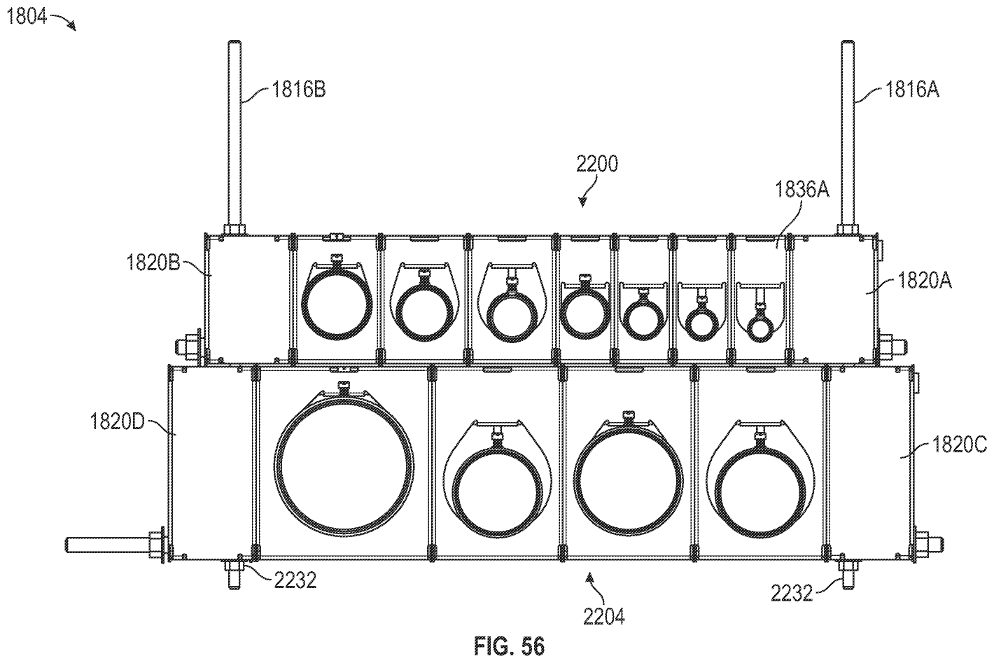

Referring to FIGS. 55 and 56, in some configurations, multiple rows of support bodies may be stacked in a single coupler system 1804. For example, as illustrated in FIG. 55 a first support body row 2200 may be connected to a second support body row 2204 by hanger rods. The first support body row 2200 may include a plurality of support bodies 1836 secured between a first set of hanger bodies (e.g., first and second hanger bodies 1820A, 1820B), and the second support body row 2204 may similarly include a plurality of support bodies 1836 secured between a second set of hanger bodies (e.g., third and fourth hanger bodies 1820C, 1820D). As illustrated in FIGS. 55 and 56, first and second hanger rods 1816A, 1816B may extend through the first and second sets of hanger bodies to connect the first and second support body rows 2200, 2204. Specifically, the first hanger rod 1816A may extend through the first and third hanger bodies 1820A, 1820D, and the second hanger rod 1816B may extend through the second and fourth hanger bodies 1820B, 1820D. The hanger rods 1816A, 1816B may therefore secure and suspend both the first and second support body rows 2200, 2204.

Referring specifically to FIG. 56, the first and second support body rows 2200, 2204 may include a different number of support bodies 1836, or may include support bodies 1836 of varying widths and heights. As described above, hanger bodies may include the first and second slots 2148, 2150 (as illustrated in FIGS. 52A-53) that may advantageously allow the hanger bodies, and therefore the support bodies connected between the hanger bodies, to be shifted axially relative to a connector rod that extends through and secures the connector and hanger bodies. The hanger bodies 1820A, 1820B, 1820C, 1820D may therefore allow the first and second support body rows 2200, 2204 to be shifted radially relative to the hanger rods 1816A, 1816B, to account for any alignment issues. As illustrated in FIG. 56, the second support body row 2204 may be wider than the first support body row 2200, however shifting one of or more of the first and second support body rows 2200, 2204 by slidably moving the first and second hanger rods 1816A, 1816B relative to one or more of the hanger bodies 1820A, 1820B, 1820C, 1820D (as shown in FIGS. 52A-52B) may allow both the first and second support body rows 2200, 2204 to be suspended by the hanger rods 1816A, 1816B.

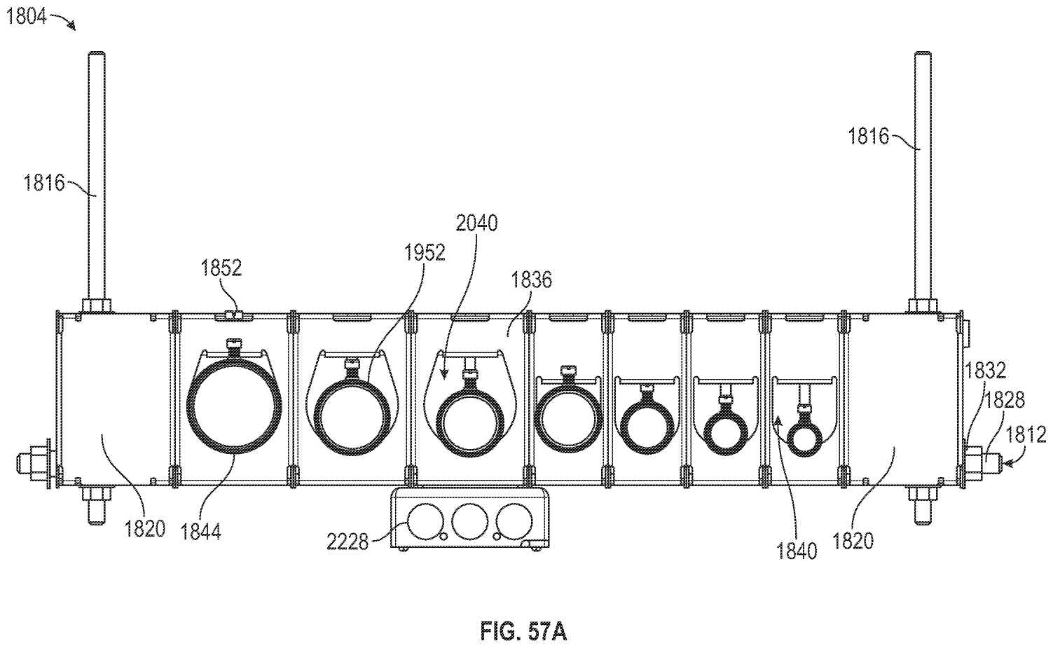

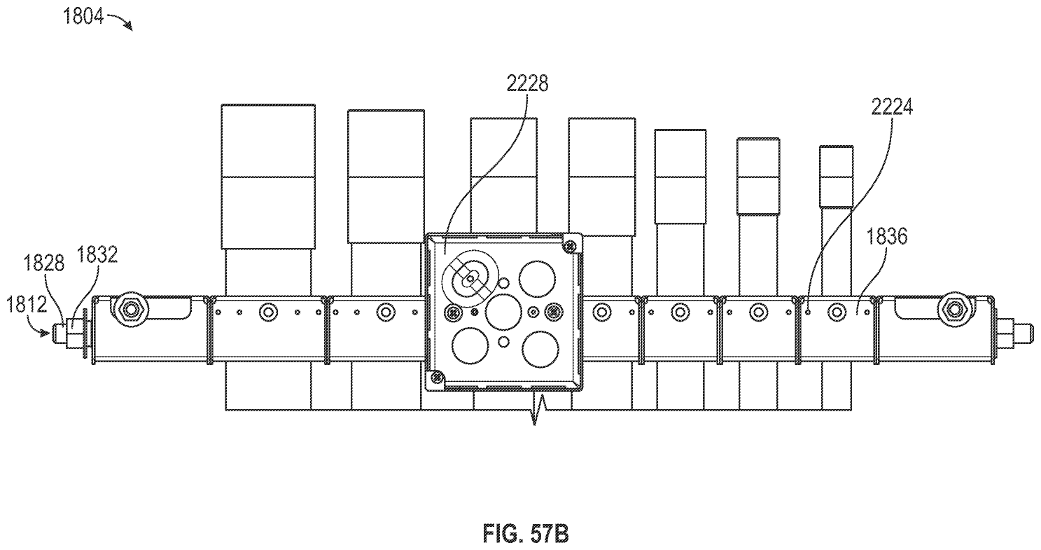

Referring to FIGS. 57A and 57B, the support bodies 1836 may include one or more fastening holes 2224. The one or more fastening holes 2224 may allow equipment (e.g., an electrical box 2228) to be secured to the bottom of the coupler system 1804. In the illustrated example, the electrical box 2228 is secured to one of the support bodies 1836, however in other configurations, a single piece of equipment (e.g., a longer electrical box) may be secured to two or more of the support bodies 1836.

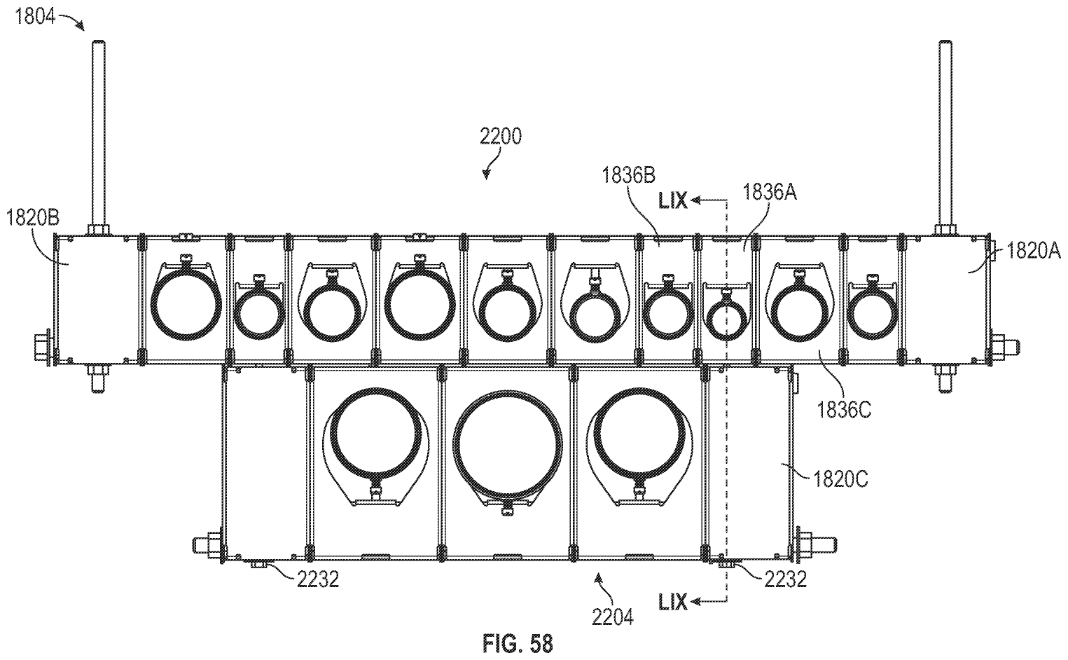

Referring to FIGS. 58 and 59, as described above, the viewing aperture 1920 of the support bodies 1836 may be configured to receive a fastener to secure a structure to the support body 1836. In the present example, the second support body row 2204 may be fastened to the first support body row 2200. Referring specifically to FIG. 59, a fastening rod 2232 may extend through the third hanger body 1820C of the second support body row 2204 (e.g., through the first and second slots 2148, 2150), and may be fastened to one of the support bodies 1836 of the first support body row 2200. Specifically, the fastening rod 2232 may be fastened to the viewing aperture 1920 of one of the support bodies 1836 of the first support body row 2200. As illustrated in FIG. 58, multiple of the hanger bodies 1820 and the fastening rods 2232 may couple the second support body row 2204 to the first support body row 2200.

In some examples, the inclusion of extension passages can allow a support assembly to be expanded after initially installed or at other times. Referring to FIGS. 60A and 60B, as described above, extension passages of the support bodies 1836 and the hanger bodies 1820 can be configured to receive and retain an extension rod 2080. As illustrated in FIG. 60A the extension rod 2080 may extend through and aid the coupling of the hanger and support bodies 1820, 1836 of the first support body row 2200. In some configurations, the extension rod 2080 may be longer than the connector rod 1828, and may therefore extend beyond the connector rod 1828. The portion of the extension rod 2080 that extends beyond the connector rod 1828 may extend through and suspend a third support body row 2248 including a plurality of support bodies 1836, that may not be supported by or connected to the connector rod 1828. The extension rod 2080 suspending extra support bodies may allow for an increased number of support bodies to be supported by a set of hanger rods.

Still referring to FIGS. 60A and 60B, a spacer structure may be disposed between the first and third support body rows 2200, 2248 to account for the connector rod 1828 and the connector rod fasteners 1832 protruding from first and second hanger bodies 1820A, 1820B. In some configurations, an extender body 2252 may be suspended by the extension rod 2080 between the third support body row 2248 and the first or second hanger body 1820A, 1820B. More specifically, the extension rod 2080 may extend through an extender body support passage 2254 of the extender body 2252. The extender body 2252 may include a saddle 2256 that extends around the end of the connector rod 1828 and the connector rod fasteners 1832.

As shown in the illustrated examples, the extender body 2252 may thus provide a structural spacer between the first and third support body rows 2200, 2248, to reduce interference caused by the connector rod 1828 and the connector rod fasteners 1832. Furthermore, though not explicitly illustrated, the extender body 2252 may include one or more openings to receive the extension rod 2080. In some configurations, the one or more extend extension rod openings may include flanges (e.g., protrusions) to aid the transfer of shear between the extender body 2252 and adjacent hanger bodies 1820 or support bodies 1836.

In some cases, contractors may underestimate a number of coupler systems and spacer systems needed when prefabricating the above-described modular support systems for a project. Although the conduit passages of the support bodies may be sized to receive a specific diameter of conduit, conduit passages may retain lengths of conduit of any diameter less than or equal to the diameter of the conduit passage via the conduit fastener. It is therefore also appreciated that installers may include one or more coupler systems and spacer systems with different diameter conduit passages along a length of conduit without compromising the integrity or function of the modular support system.

Thus, examples of the disclosed technology can provide improved systems for supporting conduit or other equipment. For example, various configurations of support bodies can be variously and adaptably arranged to allow fast and customizable assembly and installation of a wide range of conduit (or other) arrays. Further, some examples can similarly provide improved devices for aligning, connecting, and securing lengths of conduit into a desired arrangement.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise specified or limited, directional terms are presented only with regard to the particular configuration and perspective described. For example, reference to features or directions as “horizontal,” “vertical,” “front,” “rear,” “left,” “right,” “upper,” “lower,” and so on are generally made with reference to a particular figure or example and are not necessarily indicative of an absolute orientation or direction. However, relative directional terms for a particular configuration may generally apply to alternative orientations of that configuration. For example, “front” and “rear” directions or features (or “right” and “left” directions or features, and so on) may be generally understood to indicate relatively opposite directions or features for a particular configuration, regardless of the absolute orientation of the configuration (or relative orientation relative to environmental structures). “Lateral” and derivatives thereof generally indicate directions that are generally perpendicular to a vertical direction for a relevant reference frame.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

As used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Unless otherwise limited or defined, the terms “about” and “approximately,” as used herein with respect to a reference value, refer to variations from the reference value of ±20% or less (e.g., ±15, ±10%, ±5%, etc.), inclusive of the endpoints of the range. Similarly, as used herein with respect to a reference value, the term “substantially equal” (and the like) refers to variations from the reference value of less than ±5% (e.g., ±2%, ±1%, ±0.5%) inclusive.

Unless otherwise limited or defined, “substantially parallel” and the like indicate a direction that is within ±12 degrees of a reference direction (e.g., within ±6 degrees or ±3 degrees), inclusive. Correspondingly, “substantially vertical” and the like indicates a direction that is substantially parallel to the vertical direction, as defined relative to gravity, with a similarly derived meaning for “substantially horizontal” (relative to the horizontal direction). Likewise, unless otherwise limited or defined, “substantially perpendicular” and the like indicates a direction that is within ±12 degrees of perpendicular a reference direction (e.g., within ±6 degrees or ±3 degrees), inclusive. Discussion of directions “transverse” to a reference direction indicate directions that are not substantially parallel to the reference direction. Correspondingly, some transverse directions may be perpendicular or substantially perpendicular to the relevant reference direction.

The previous description of the disclosed configurations is provided to enable any person skilled in the art to make or use the disclosed technology. Various modifications to these configurations will be readily apparent to those skilled in the art, and the generic principles defined herein may be applied to other configurations without departing from the spirit or scope of the disclosed technology. Thus, the disclosed technology is not intended to be limited to the configurations shown herein but is to be accorded the widest scope consistent with the principles and novel features disclosed herein.

We claim:

1. A modular support system comprising:
a first hanger body secured to a first hanger rod;
a second hanger body secured to a second hanger rod;
a plurality of support bodies arranged between the first hanger body and the second hanger body, each support body of the plurality of support bodies including:
a conduit passage that receives a corresponding length of conduit; and
a support passage that is transverse to the conduit passage; and
a connector rod extending through the first and second hanger bodies and the plurality of support bodies, the connector rod being supported by the first and second hanger rods via the first and second hanger bodies, and the plurality of support bodies being collectively supported by the connector rod to support the lengths of conduit.

2. The modular support system of claim 1, wherein the first and second hanger bodies are rotatable relative to the plurality of support bodies, about an axis defined by the connector rod, between:
an installation orientation in which the first and second hanger rods extend in a first direction transverse to the lengths of conduit; and
a transport orientation in which the first and second hanger rods extend at an angular offset from the first direction.

3. The support system of claim 2, wherein, with the first and second hanger bodies in the transport orientation, the first and second hanger rods extend substantially in parallel with the lengths of conduit.

4. The support system of claim 1, wherein each support body of the plurality of support bodies includes a protrusion and an opening; and
wherein for adjacent support bodies of the plurality of support bodies, the protrusion of a first of the adjacent support bodies engages the opening of a second of the adjacent support bodies, and the opening of the first of the adjacent support bodies engages the protrusion of a third of the adjacent support bodies.

5. The support system of claim 4, wherein the protrusions and the openings are aligned along the connector rod.

6. The support system of claim 5, wherein the first hanger body includes an opening that engages the protrusion of a support body at a first end of the adjacent support bodies and the second hanger body includes a protrusion that engages the opening of a support body at a second end of the adjacent support bodies.

7. The support system of claim 5, wherein each support body of the plurality of support bodies further includes a second protrusion and a second opening; and
wherein for the adjacent support bodies, the second protrusion of the first of the adjacent support bodies engages the second opening of the third of the adjacent support bodies, and the second opening of the first of the adjacent support bodies engages the protrusion of a third of the adjacent support bodies.

8. The support system of claim 1, wherein the first hanger body is a stamped hanger body substantially identical to the second hanger body; and
at least a first support body of the plurality of support bodies is a stamped support body substantially identical to a second support body of the plurality of support bodies.

9. The support system of claim 1, wherein the first hanger body includes a slot that extends substantially in parallel with the connector rod; and
the first hanger rod is received through and slidably adjustable along the slot.

10. The support system of claim 1, further comprising:
an extender assembly that includes:
an extender body that includes an extender-body support passage; and
a second plurality of support bodies, each support body of the second plurality of support bodies including:
a second conduit passage that receives a corresponding second length of conduit; and
a second support passage that is transverse to the second conduit passage; and
a second connector rod that extends through the second support passages, through the extender-body support passage, and through one or more of: the first hanger body, the second hanger body, or at least one of the plurality of support bodies;
wherein the second connector rod is supported by the first and second hanger rods via the first and second hanger bodies to support the second lengths of conduit.

11. The support system of claim 10, wherein the extender body further includes a saddle that extends around an end of the connector rod.

12. The support system of claim 1, further comprising a spacer assembly that includes:
a plurality of spacer bodies, each spacer body of the plurality of spacer bodies including:
a spacer-body conduit passage that receives a corresponding one of the lengths of conduit that extends through the conduit passages of the plurality of support bodies; and
a spacer-body support passage that is transverse to the spacer-body conduit passage; and
a spacer-assembly connector rod extending through the spacer-body support passages to secure the spacer bodies together.

13. The support system of claim 1, wherein at least one support body of the plurality of support bodies is a stamped body that includes a top wall and a recessed arm that supports a set screw, with the set screw recessed below the top wall and aligned above the conduit passage to secure the corresponding length of conduit.

14. The support system of claim 1, further comprising:
a third hanger body, with the first hanger rod extending therethrough;
a fourth hanger body, with the second hanger rod extending therethrough; and
a second plurality of support bodies arranged between the third hanger body and the fourth hanger body to support corresponding second lengths of conduit.

15. The support system of claim 1, further comprising:
a second plurality of support bodies secured with fasteners to bottom walls of the plurality of support bodies, to support corresponding second lengths of conduit.

16. A method of prefabricating a modular support system, the method comprising:
securing a first hanger body to a first hanger rod;
securing a second hanger body to a second hanger rod;
aligning a plurality of support bodies between the first and second hanger bodies, each of the support bodies of the plurality of support bodies including: a conduit passage; and a support passage that is transverse to the conduit passage;
inserting a connector rod through the plurality of support bodies and the first and second hanger bodies so that the connector rod is arranged to be supported by the first and second hanger rods via the first and second hanger bodies and the plurality of support bodies are collectively supported by the connector rod;
inserting a corresponding length of conduit into the conduit passage of each support body of the plurality of support bodies; and
securing the lengths of conduit within the conduit passages for transport collectively with the first and second hanger bodies and the first and second hanger rods.

17. The method of claim 16, wherein the first and second hanger bodies are secured for transport in a transport orientation in which the first and second hanger rods extend substantially in parallel with the lengths of conduit, and are rotatable about the connector rod to an installation orientation in which the first and second hanger rods extend transverse to the lengths of conduit.

18. The method of claim 16, further comprising:
securing the first hanger rod through first and second slots on the first hanger body, to be slidable along the slots between different hanging positions.

19. A method of installing a modular support system, the method comprising:
securing a first hanger rod to a building structure, the first hanger rod being secured to a first hanger body; and
securing a second hanger rod to the building structure, the second hanger rod being secured to a second hanger body;
the first and second hanger rods thereby supporting the first and second hanger bodies relative to the building structure, with a connector rod extending through the first and second hanger bodies and through support passages of a plurality of support bodies arranged between the first hanger body and the second hanger body, so that the connector rod is supported by the first and second hanger rods via the first and second hanger bodies, and the plurality of support bodies are collectively supported by the connector rod to support lengths of conduit received transversely to the connector rod through conduit passages of the support bodies.

20. The method of claim 19, further comprising:
before securing the first and second hanger rods to the building structure, rotating the first and second hanger bodies about an axis defined by the connector rod, from:
a transport orientation in which the first and second hanger rods extend substantially in parallel with the lengths of conduit; and
an installation orientation in which the first and second hanger rods extend substantially perpendicular to the lengths of conduit.
